(19) United States
(12) Patent Application Publication
(10) Pub. No.: US 2008/0311429 A1
(43) Pub. Date: Dec. 18, 2008

(54) MAGNETIC FILM, MAGNETIC RECORDING/ REPRODUCING DEVICE, AND POLARIZATION CONVERSION COMPONENT

(76) Inventors: Tadao KATSURAGAWA, Tokyo (JP); Takayoshi Sasaki, Ibaraki (JP); Minoru Osada, Ibaraki (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/135,472

(22) Filed: Jun. 9, 2008

(30) Foreign Application Priority Data
Jun. 15, 2007 (JP) 2007-158289
Jun. 15, 2007 (JP) 2007-158290
Jun. 15, 2007 (JP) 2007-158291

(51) Int. Cl. G11B 5/66; G11B 5/706

(52) U.S. Cl. 428/820.1; 428/611; 428/573; 428/552; 428/846.2

(57) ABSTRACT

The disclosure provides a magnetic film which includes a titania nanosheet which is formed on a transparent substrate and contains a layered titanium oxide in which at least one magnetic element is substituted for a Ti lattice position, the titanium oxide being expressed by a formula: Ti₂₋ₓMₓO₄ where M is at least one kind of transition metal elements chosen from among V, Cr, Mn, Fe, Co, Ni, and Cu, and 0<x<2, a dispersant surrounding the nanosheet, and a water-soluble organic compound.

### BACKGROUND OF THE INVENTION

1. Field of the Invention

This invention relates to a magnetic film using a titania nanosheet to provide a large Faraday rotation angle and a high visible light transmittance, relates to a magnetic recording/reproducing device using the titania nanosheet, and relates to a polarization conversion component using the titania nanosheet.

2. Description of the Related Art

A magneto-optical component using the Faraday effect of a transparent magnetic film provides many advantages. For example, the durability of a magnetic film is high, i.e., the resistances to temperature, humidity, medicine, light, etc. are high, and the film flexibility is high. If a plastic film is used as a substrate, it can be used as a flexible magneto-optical component. The rewriting speed of a magneto-optical component is on the order of nanoseconds and very high, and the write-once recording using a magnetic pen is possible. There are several proposals of magneto-optical components. For example, the following magneto-optical components using the Faraday effect are proposed.

Japanese Patent Publication No. 56-15125 discloses a magneto-optical component using a thin film of rare-earth-iron-garnet as a transparent magnetic film. Japanese Laid-Open Patent Application No. 62-119758 discloses a magneto-optical component using particles of rare-earth-iron-garnet as an applied film which is to be applied to the substrate. Moreover, a magneto-optical component using a single crystal of rare-earth-iron-garnet is also proposed (see Journal of Applied Physics, 76(3), p. 1910-1919, 1 Aug. 1994).

However, the heating temperature for forming a thin film of rare-earth-iron-garnet was in a range between 500 degrees C. and 700 degrees C., the substrate to be used was restricted, and the use of a plastic film was impossible.

When particles of rare-earth-iron-garnet are used, high temperature for crystallization was not needed. However, due to a large amount of light scattering by the particle interfaces, the transparency to visible light was not acquired in a practical range of thickness, which causes the contrast ratio to be lowered. Therefore, a practical level of contrast ratio was not obtained.

When a single crystal of rare-earth-iron-garnet is used, it was difficult to obtain a film with a large area, the flexibility was not obtained, and the production was expensive.

Meanwhile, Japanese Laid-Open Patent Application No. 2006-199556 discloses a lamination method using a titania magnetic semiconductor thin film as a transparent magnetic film. This lamination method is a film formation method (mutual self-organization) in which multilayer films of titania magnetic semiconductor nanosheets/polycations are fabricated by the electrostatic layer-by-layer assembly, as shown in FIG. 1. However, this method was time consuming, the productivity was low, and the feasibility was very low.

FIG. 6 shows the absorbance characteristics of a titania nanosheet obtained by using the lamination method disclosed in Japanese Laid-Open Patent Application No. 2006-199556. As shown in FIG. 6, this titania nanosheet shows a low level of absorbance in the visible-light range of wavelengths of the applied light.

If the lamination of the titania magnetic semiconductor nano thin film and organic film is repeated about 30 times, opacity arises due to light scattering and the film transparency falls. Because the thickness for acquiring a practical Faraday rotation angle is about 1 micrometer, the repetition of the lamination about 1000 times is needed, and the utilization of the lamination method is difficult to obtain a magneto-optical component.

In addition, it is already reported that the lamination of two kinds of magnetic titania semiconductor nanosheets, a Co-substituted nanosheet and a Fe-substituted titania nanosheet, yields a rotation angle of 30 degrees per micrometer (see Adv. Mater., 2006, 18, p. 295-299).

However, in order to obtain a Faraday rotation angle more than 30 degrees, formation of a magnetic film with about 1-micrometer thickness is required. Thus, it is very difficult to obtain a transparent magnetic film by using the lamination method disclosed in Japanese Laid-Open Patent Application No. 2006-199556.

A conceivable method of obtaining a transparent magnetic film, which does not require heating of the substrate to several hundreds of degrees C. in the vacuum devices according to various kinds of PVD (physical vacuum deposition) method, is to use a titania nanosheet.

However, the lamination method according to the related art in which respective layers each including a nanosheet and an organic film are laminated one by one is not realistic with respect to productivity as mentioned above, and if the lamination structure has about 30 layers or more, translucency will arise due to light scattering.

### SUMMARY OF THE INVENTION

In one aspect of the invention, the present disclosure provides an improved magnetic film in which the above-described problems are eliminated.

In one aspect of the invention, the present disclosure provides a magnetic film which shows a high visible-light transmittance (80% or more) and a large Faraday rotation angle (10 degrees or more), the magnetic film not requiring substrate heating, enabling the film formation in the air at normal temperature, and enabling use of a plastic film as a substrate.

In an embodiment of the invention which solves or reduces one or more of the above-mentioned problems, the present disclosure provides a magnetic film comprising: a titania nanosheet which is formed on a transparent substrate and contains a layered titanium oxide in which at least one magnetic element is substituted for a Ti lattice position, the titanium oxide being expressed by a formula: Ti₂₋ₓMₓO₄ where M is at least one kind of transition metal elements chosen from among V, Cr, Mn, Fe, Co, Ni, and Cu, and 0<x<2; a dispersant surrounding the titania nanosheet; and a water-soluble organic compound.

According to the magnetic film of this invention, a high visible light transmittance (80% or more) and a large faraday rotation angle (10 degrees or more) can be acquired.

In one aspect of the invention, the present disclosure provides a magnetic recording/reproducing device which includes the titania nanosheet and is able to attain the multilayer recording and reproduction using the Faraday effect, by using the lamination film containing the laminated structure of titania nanosheets and polymer layers for magnetic recording and reproduction.

In an embodiment of the invention which solves or reduces one or more of the above-mentioned problems, the present disclosure provides a magnetic recording/reproducing device comprising: a lamination film formed on a transparent substrate and containing a laminated structure of titania nanosheets and polymer layers, each titania nanosheet containing a layered titanium oxide in which at least one magnetic element is substituted for a Ti lattice position, the titanium oxide being expressed by a formula: Ti₂₋ₓMₓO₄ where M is at least one kind of transition metal elements chosen from among V, Cr, Mn, Fe, Co, Ni, and Cu, and 0<x<2; a magnetic field applying unit applying a magnetic field to the lamination film in a direction perpendicular to a surface of the lamination film; a laser light source outputting a laser beam; a light converging unit causing the laser beam to converge on an arbitrary position in the lamination film; and a rotation angle measuring instrument measuring an angle of rotation of a plane of polarization of the laser beam of the laser light source output from the lamination film.

According to the magnetic recording/reproducing device of this invention, the multilayer recording and reproduction using the Faraday effect which was difficult according to the related art can be attained by using the lamination film containing the laminated structure of titania nanosheets and polymer layers for magnetic recording and reproduction.

In one aspect of the invention, the present disclosure provides a polarization conversion component which includes the titania nanosheet and is able to carry out polarized light separation and polarization conversion at a time using a single thin film, enabling miniaturization of the polarization conversion component and facilitation of the manufacture process.

In an embodiment of the invention which solves or reduces one or more of the above-mentioned problems, the present disclosure provides a polarization conversion component comprising: a substrate; and a lamination film formed on a surface of the substrate slantingly with a given inclination angle to the surface of the substrate, the lamination film including an alternate lamination of transparent magnetic layers and transparent organic layers, each transparent magnetic layer containing a layered titanium oxide in which at least one magnetic element is substituted for Ti lattice positions, the titanium oxide being expressed by a formula: Ti₂₋ₓMₓO₄ where M is at least one kind of transition metal elements chosen from among V, Cr, Mn, Fe, Co, Ni, and Cu, and 0<x<2; wherein a birefringence is formed by a layered structure of the lamination film in which a density of the lamination film changes to the substrate periodically and slantingly based on a difference in density between the magnetic layers and the organic layers, wherein a thickness of the lamination film is adjusted so that, when a light ray enters at right angles to the surface of the substrate, the polarization conversion component outputs a linearly polarized light ray along a specific polarization direction.

According to the polarization conversion component of this invention, it is not necessary to repeat polarized light separation and polarization conversion by separate films, it is possible to carry out polarized light separation and polarization conversion at a time using a single thin film, and miniaturization of the polarization conversion component and facilitation of the manufacture process can be attained.

Other objects, features and advantages of the present invention will become more apparent from the following detailed description when read in conjunction with the accompanying drawings.

### BRIEF DESCRIPTION OF THE DRAWINGS

FIG. 1 is a diagram showing the composition of a lamination film including a titania nanosheet and a polymer layer according to the related art.

FIG. 2A and FIG. 2B are diagrams showing the improvement in the arrangement characteristic of a nanosheet at a time of application of a magnetic field during formation of a magnetic film.

FIG. 3 is a cross-sectional view showing the composition of a magnetic film in an embodiment of the invention.

FIG. 4 is a diagram showing an X-ray diffraction chart of a magnetic film to which a strong magnetic field is applied.

FIG. 5 is a cross-sectional view showing the composition of a magneto-optical component including a magnetic film in an embodiment of the invention.

FIG. 6 is a diagram showing the absorbance characteristic of a titania nanosheet according to the related art.

FIG. 7 is a cross-sectional view showing the composition of a magnetic recording/reproducing device in an embodiment of the invention.

FIG. 8 is a cross-sectional view showing the lamination structure of a lamination film for use in the magnetic recording/reproducing device of the invention.

FIG. 9 is a cross-sectional view showing the lamination structure of a lamination film including different kinds of nanosheets for use in the magnetic recording/reproducing device of the invention.

FIG. 10A and FIG. 10B are a plan view and a cross-sectional view showing the two-dimensional arrangement of chips of a lamination film.

FIG. 11 is a cross-sectional view showing the composition of a recording/reproducing head in which a laser light source, a light converging unit, a magnetic field applying unit and a rotation angle measuring instrument are integrated.

FIG. 12 is a cross-sectional view showing the composition of a rotation angle measuring instrument.

FIG. 13 is a cross-sectional view showing the composition of a polarization conversion component in an embodiment of the invention.

FIG. 14 is a diagram for explaining separation of an incident light by a birefringence film.

FIG. 15 is a diagram for explaining a method of manufacturing a lamination nanosheet.

FIG. 16 is a cross-sectional view showing the composition of a laminated type polarization conversion component.

FIG. 17 is a cross-sectional view showing the composition of another laminated type polarization conversion component.

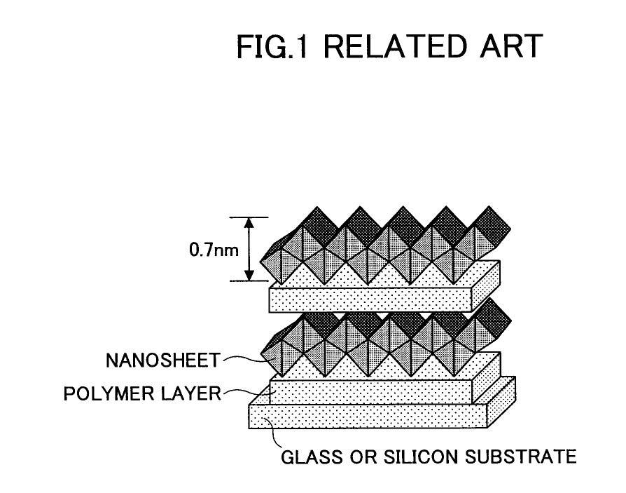

### DETAILED DESCRIPTION OF THE PREFERRED EMBODIMENTS

A description will be given of a magnetic film in an embodiment of the invention, its manufacturing method, and a magneto-optical component using the same.

The magnetic film in this embodiment includes: a titania nanosheet which is formed on a transparent substrate and contains a layered titanium oxide in which at least one magnetic element is substituted for a Ti lattice position; a dispersant surrounding the titania nanosheet; and a water-soluble organic compound.

Examples of the material of the substrate may be any of transparent ceramic or inorganic materials, including silica glass, GGG (gadolinium gallium garnet), sapphire, lithium tantalate, crystallization transparent glass, Pyrex (registered trademark) glass, Al₂O₃, Al₂O₃—MgO, MgO—LiF, Y₂O₃, LiF, BeO, ZrO₂, Y₂O₃, ThO₂, CaO, etc.

In this invention, a magnetic titania ultrathin film which is useful as a transparent magnetic substance is used as the titania nanosheet. The titanium oxide in this super-thin film is expressed by the formula: Ti₂₋ₓMₓO₄ (where M denotes at least one kind of transition metal elements chosen from among V, Cr, Mn, Fe, Co, Ni, and Cu, and 0<x<2). The magnetic titania ultrathin film is a magnetic semiconductor nano film containing flake particles (called a nanosheet) obtained by exfoliating a crystal structure of a layered titanium oxide in which at least one kind of metal (magnetic element) is substituted for a Ti lattice position by chemical preparation into one layer as the basic minimum unit.

Next, a method of manufacturing this nanosheet will be described.

An acid aqueous solution, such as hydrochloric acid, is contacted to titanium oxide particles having a layer structure. The resulting product is dried after filtration and washing, all the alkali metal ions existing between layers before the processing are replaced by hydrogen ions, and a hydrogen type substance is obtained.

Next, the obtained hydrogen type substance is put into a solution of amine, and it is agitated, so that it is set in a colloid state. At this time, the layers forming the layer structure are exfoliated in respective sheets. The acid treatment at the preceding stage is disclosed in Japanese Patent Publication No. 6-88786, Japanese Patent No. 1966650, Japanese Patent Publication No. 6-78166, Japanese Patent No. 1936988, Japanese Laid-Open Patent Application No. 9-25123, and Japanese Patent No. 2671949.

As the layered titanium oxide which is a starting compound, a layered titanium oxide Ti₂₋ₓMₓO₄ in which at least one kind of transition metal elements (V, Cr, Mn, Fe, Co, Ni, Cu) is substituted for a Ti lattice position of lepidocrocite type titanate (where M denotes at least one kind of transition metal elements chosen from among V, Cr, Mn, Fe, Co, Ni, and Cu, and 0<x<2) or the like may be uses. It is preferred that Fe or Co element is substituted in a range of 0<x<0.8.

As a transition metal element which induces the ferromagnetic characteristics above room temperature, it is desirable that Fe or Co element is substituted in a range of 0<x<0.8. However, adjustment of concentration of at least one kind of transition metals chosen from among V, Cr, Mn, Fe, Co, and Ni, a combination of two or more kinds of metals, and addition of dopant, etc. enables adjustment of ferromagnetic characteristics (for example, susceptibility, magneto optics characteristics, magnetic transition temperature, etc.). Substituting two kinds of transition metal elements, such as Co and Fe, in one nanosheet simultaneously is a leading method for acquiring a large Faraday rotation angle.

The acid treatment of the layered titanium oxide Ti₂₋ₓMₓO₄ is performed to change it into a hydrogen type solution (H_{0.8}Ti₂₋ₓMₓO₄ nH₂O), and shaking of the same in a suitable amine solution is performed so that the solution is in a sol state.

The layers forming the mother crystal, i.e., nanosheets, are distributed in this sol solution respectively. The thickness of a nanosheet is dependent on the crystal structure of the start mother crystal and it is very small (about 1 nm). On the other hand, the horizontal size is on the order of micrometers. The titania nanosheet has a high two-dimensional anisotropy.

There is the problem of the related art that if the dispersion liquid of a titania nanosheet is applied to a thickness of about 1 micrometer by using a spin coater or another spreading method, transparency is not acquired due to light scattering from the nanosheet laminated at random. In order to eliminate the problem, it is preferred that TBA (tetra-butyl-ammonium) is used as the dispersant of titania nanosheet dispersion liquid. Of course, another dispersant is also usable. However, Because the titania nanosheet has a negative electric charge, the material which does not generate condensation by electric combination is needed. TBA is used as a dispersant to an aqueous solvent. At the time of film formation, TBA takes such a structure which wraps almost all the surfaces of the nanosheet, so that the nanosheet is surrounded by the TBA.

By using a water soluble polymer as the water-soluble organic compound, in addition to the dispersant, light scattering is reduced and the transparency of the magnetic film is ensured. It appears that the light scattered from the nanosheet passes the magnetic film like an optical waveguide by the use of the added transparent polymer.

If a too small amount of the water soluble polymer is used, the function as a passage of light cannot be achieved. If a too large amount of the water soluble polymer is used, the function as a magnetic film will fall excessively. The optimal mixed amount in the range of 0 to 40% by weight has been examined. Transparency of the magnetic film improves in proportion to the mixed amount. As the results of experiments (Example 1), it was confirmed that the optimal mixed amount is in the range of 5 to 30% by weight. The magnetic characteristics, such as a Faraday rotation angle will fall if the mixed amount exceeds 31% by weight. It was confirmed that the mixed amount smaller than 30% by weight is preferred.

By using a water soluble polymer, the effect of decreasing sharply the air bubbles contained in the dispersant, such as TBA, arises. If a water soluble polymer is not used, the film after the film formation and drying includes many holes (the length from several hundreds of nanometers to several micrometers), transparency of the film falls due to light scattering. However, if a water soluble polymer is used, such holes are not observed by the cross-sectional TEM observation, and as a result, the transparency of the magnetic film improves sharply. Because the transparency contributes to the signal strength at the time of light transmission, the transparency of the magnetic film is important.

The water soluble polymer is a polymer which is dissolved in water. Examples of the water soluble polymer may include natural polymers, such as starch, casein, glue, gelatin, gum arabic, sodium alginate and pectin, semi-synthetic polymers, such as carboxymethylcellulose, methylcellulose and viscose, synthetic polymers, such as polyvinyl alcohol, polyacrylamide, polyethylene imine, sodium polyacrylate, polyethylene oxide, and polyvinyl pyrrolidone, etc.

It is preferred to remove the moisture, absorbed by TBA, from the transparent magnetic film after film formation, by heating or UV irradiation. It was confirmed that the Faraday effect of the nanosheet layer improves further if the moisture is removed. Heating may be performed at 100-150 degrees C. for about 10 minutes to several hours. It is preferred that the duration of UV irradiation is in the range from several hours to several tens of hours. For example, the Faraday rotation angle at the time of applying to a thickness of 1 micrometer (although it is dependent on the magnetic atom substitution conditions of the titania nanosheet) was in a range of 5-20 degrees. The value of the Faraday rotation angle obtained is practically applicable.

It is preferred that the water soluble polymer in the magnetic film of this invention is gelatin. The titania nanosheet used in this invention is preferably laminated. In this respect (lamination of a nanosheet), gelatin is desirable among the water soluble polymers. For example, the intensities of the diffraction peak (2θ≈4.8 degrees) in the X-ray diffraction diagram for respective cases in which carboxymethylcellulose, hydroxyethyl cellulose, polyvinyl alcohol, and gelatin are used as the water soluble polymer in the amount of 10% by weight of the nanosheet when the film is applied by a thickness of 1 micrometer were as follows:

| | |
|---|---|
| carboxymethylcellulose | 33 kcounts/s |
| hydroxyethyl cellulose | 11 kcounts/s |
| polyvinyl alcohol | 18 kcounts/s |
| gelatin | 75 kcounts/s. |

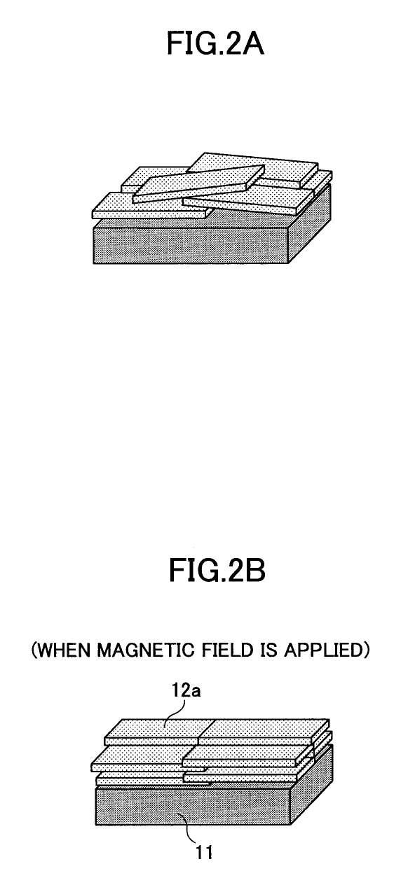

The intensity of the diffraction peak (2θ≈4.8 degrees) appears in accordance with the lamination cycle of the nanosheets. This diffraction peak intensity is called the primary diffraction line, and, otherwise, the secondary diffraction line and others may appear. As shown in FIG. 2A and FIG. 2B, the diffraction peak intensity increases in proportion to the level of regularity of the arrangement of nanosheets 12a on a substrate 11 (the level of regularity of the arrangement of FIG. 2B is higher than that of FIG. 2A). It can be said that the intensity of the diffraction peak in the case of gelatin is desirable.

If the cross sections of the films are observed by the TEM method, the number of holes in the cross section of the film and the surface unevenness in the case of gelatin are smaller than in the cases of the other three water soluble polymers mentioned above. A high film transparency can be obtained in the case of gelatin which enables a high contrast ratio for use in a display. Thus, gelatin is the most desirable for the water-soluble organic compound. It is preferred to use gelatin with its proteinic decomposition rate raised, because such gelatin can reduce the condensation with a nanosheet.

It is preferred that the nanosheet in the magnetic film of the invention is a mixture of two kinds of nanosheets: a Co-substituted titania nanosheet and a Fe-substituted titania nanosheet. It was confirmed that a Faraday rotation angle obtained when the dispersion liquid in which the Co- and Fe-substituted titania nanosheets are mixed is applied is larger than that obtained when the two titania nanosheets are applied separately. For example, when a magnetic film is formed with a Co-substituted titania nanosheet solely, its Faraday rotation angle for the wavelength of 450 nm was about 2 degrees/micrometer, and the Faraday rotation angle in the case of Fe-substituted titania nanosheet was about 1 degree/micrometer. The Faraday rotation angle in the case of the dispersion liquid of the mixture was about 6 degrees/micrometer, indicating a sharp increase. The following three kinds of the nanosheet lamination in the film can be considered: (1) lamination of a Co-substituted titania nanosheet and a Fe-substituted titania nanosheet; (2) lamination of a Co-substituted titania nanosheet and a Co-substituted titania nanosheet; and (3) lamination of a Fe-substituted titania nanosheet and a Fe-substituted titania nanosheet.

It appears that the inclusion of the lamination (1) in the film results in a sharp increase of the Faraday rotation angle because of occurrence of the interlayer interaction by the transition of Co²⁺->Fe³⁺.

It is preferred to form a base layer (surface treatment layer) on the substrate surface in the magnetic film of the invention, the base layer reducing the surface contact angle to water.

As mentioned above, the periodic arrangement is important for the titania nanosheet. One of the factors for raising the periodic arrangement feature is a surface contact angle to the water on the substrate surface, and it was confirmed that the surface contact angle must be 10 degrees or less.

If a magnetic film with a thickness of 1 micrometer is formed by spin coating on a glass substrate using a dispersion liquid (gelatin-mixed liquid) of Co- and Fe-substituted titania nanosheets, a large difference appears in the intensity of the diffraction peak (2θ≈4.8 degrees) in the X-ray diffraction chart.

It was confirmed that when the arrangement feature of the nanosheets is low as shown in FIG. 2A, the resulting Faraday rotation angle becomes small. If the surface contact angle is too large, the familiarity of the nanosheets in the dispersion liquid to the substrate surface is poor, which will lower the arrangement feature of the nanosheets.

There are the known methods of reducing the surface contact angle. For example, the method of removing the stain on the surface of a substrate using the plasma, such as oxygen, ozone, nitrogen, argon, etc. is well known. However, after the surface cleaning is performed, a stain may be attached again to the surface if the substrate is exposed to the air. Such surface cleaning method is not suitable for the magnetic film of this invention which is formed in a plastic film using the liquid applying method, because a sufficient surface contact angle is not obtained.

Because the applying fluid is in a special form (for example, the thickness: 1 nm, the length: 1 micrometer, the width: 1 micrometer), and is electrically charged with a negative electric charge, the concentration of the nanosheet dispersion liquid cannot be raised. It is required that a small surface contact angle is obtained and the surface contact angle is stably maintained at the small value for a long time.

To eliminate the problem, the magnetic film of the invention uses a method of forming a base layer on the surface of a substrate. This method is appropriate for obtaining a small surface contact angle and maintaining the surface contact angle at a small value for a long time. It is preferred to use any of the following methods: a surface treatment processing method which injects a reactant to a resin surface using an ion beam in a vacuum atmosphere; a method of applying a transparent inorganic material having a catalyst function, such as titanium oxide, by PVD, CVD, or an applying method; a method of applying an organic material, such as a surfactant; a method of forming a minute unevenness on the substrate surface, in order to form a surface treatment layer.

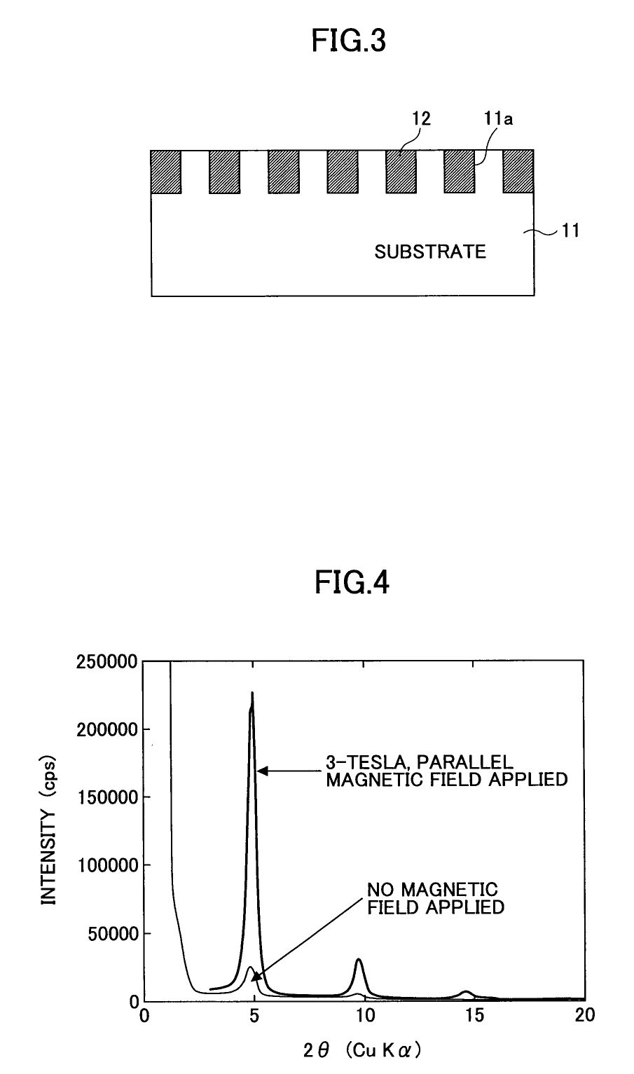

It is preferred that the magnetic film of the invention is formed in straight-line grooves arranged periodically with a constant pitch on the surface of the substrate. FIG. 3 is a cross-sectional view showing the composition of a magnetic film in an embodiment of the invention. As shown in FIG. 3, a plurality of straight-line grooves 11a are formed in the surface of a substrate 11 in rows to form a straight-line periodical structure, and the magnetic film 12 of this embodiment is arranged in each groove 11a. Accordingly, the magnetic films 12 have a straight-line periodical structure with a constant pitch on the surface of the substrate 11, and the titania nanosheets are arranged in the magnetic films 12 in the straight-line periodical structure.

The two or more rows of the straight-line grooves 11a are formed in the surface of the substrate 11 to form a straight-line periodical structure, and the magnetic films are formed therein by sputtering or vacuum deposition. This allows the Faraday rotation angle to be increased, which is disclosed in Japanese Patent No. 3628859 and Japanese Patent No. 3654553. However, the above-mentioned method uses a dry process for the film formation, which requires the substrate heating, and needs a vacuum device as the manufacturing equipment.

To eliminate the problem, the magnetic film of the invention uses a method of forming the magnetic film in which the substrate heating is unnecessary and the provision of a vacuum device is not needed. That is, a desired transparent magnetic film in which the nanosheets are included in the grooves 11a in the periodical arrangement structure is obtained only by leaving the nanosheet dispersion liquid on the surface of the substrate 11 having the grooves 11a.

If the magnetic film 12 of the invention is formed while a predetermined magnetic field is applied by the magnetic field generating device (which will be described later), the nanosheets can be arranged perpendicularly (in the depth direction of the grooves 11a) in the grooves 11a. It is possible to form a transparent magnetic media having a large perpendicular magnetic anisotropy.

Because the nanosheets have large shape anisotropy within the surface, the nanosheets arranged in the grooves 11a have a perpendicular magnetic anisotropy which results in a large interaction with light. That is, a large Faraday rotation angle can be obtained.

While a transparent magnetic substance according to the related art arranged in the grooves shows a refractive index of 2 or less, the magnetic film of the invention arranged in the grooves shows an increased refractive index ranging from 2.5 to 3. Because the magnetic film of the invention has an increased refractive index, it is possible to obtain a large Faraday rotation angle.

It is preferred that, after the nanosheet dispersion liquid, containing the layered titanium oxide particles in which the magnetic element is substituted for the Ti lattice position, the dispersant, and the water-soluble organic compound, is applied to a transparent substrate, the nanosheet dispersion liquid is dried while a predetermined magnetic field is applied, so that the magnetic film of the invention is formed.

The periodic arrangement of nanosheets (lamination structure) is the most important factor for obtaining the electron transition between the nanosheets efficiently and obtaining a large Faraday rotation angle. The application of a magnetic field during drying of the nanosheet dispersion liquid is effective in obtaining the periodic arrangement of nanosheets.

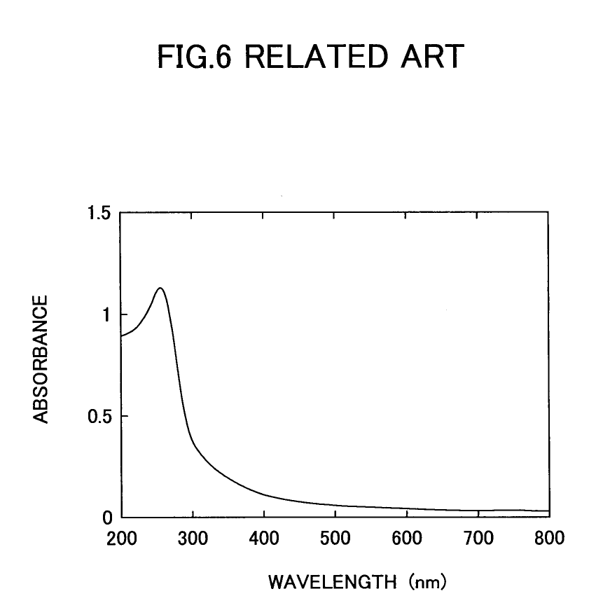

Because the saturation magnetization of each nanosheet is small, it is necessary to apply a high magnetic field which is higher than in the magnetic field orientation method according to the related art. The application of a magnetic field of 1 tesla or more is appropriate, and it is preferred that the direction of application of the magnetic field is perpendicular to the surface of the substrate or parallel to the surface of the substrate. For example, it was confirmed that the maximum peak of the X-ray diffraction chart when a three-tesla magnetic field is applied in a direction parallel to the surface of the substrate during the drying step after the nanosheet dispersion liquid is applied is about 10 times as large as that in the case in which no magnetic field is applied for the same thickness (see FIG. 4).

If a magnetic field is applied in a direction perpendicular to the surface of the substrate, the nanosheets are arranged in the surface of the substrate perpendicularly. Although the magnetic anisotropy of the nanosheets is within the substrate surface, the magnetic anisotropy of the entire magnetic film in this case is perpendicular to the surface of the substrate (perpendicular magnetic anisotropy film). The interaction with the light penetrating the surface of the substrate in a perpendicular direction is increased, and it is possible to obtain a large Faraday rotation angle.

The form of the nanosheet of this invention differs greatly from the form of alloy particle magnetic substances, such as needle magnetic iron oxide or iron. For example, the crystal of needle iron oxide has a needle-like form, the ratio of the major axis length to the minor axis length is in a range of 2-20. The nanosheet of this invention has an extremely small thickness (about 1 nm), and the size of its length and width is in a range from several hundreds of nanometers to several micrometers which size is much larger than the thickness.

Next, the magneto-optical component using the titania nanosheet in an embodiment of the invention will be explained.

The magneto-optical component of the invention contains the above-mentioned magnetic film of the invention, a polarizer layer, and a magnetic field generator. The magneto-optical component is arranged to penetrate or intercept a polarized light by magnetizing the magnetic film using the magnetic field generator.

The magnetic field generator is, for example, a magnetic coil in which a lead wire is wound or a permanent magnet. It is preferred that a micro magnetic head array in which two or more small magnetic coils are arranged in rows and columns is used as the magnetic field generator.

It is not necessary to use a metallic wiring of any of Au, Ag, Al, and Pt according to the related art. It is possible for the present invention to use a transparent electric conduction film of any of SnO₂, In₂O₃, and ZnO, which enables the magnetizing direction of magnetic particles to be reversed easily.

It is also possible to use an organic substance transparent conductive material, such as a BEDO-TTF complex having ethylene dioxy group, or a CT complex using C60 dielectric. It is possible for magneto-optical component of the invention to provide a high transmittance, which enables the displaying with a large contrast ratio to be attained.

As the polarizer layer, any of various kinds of polarization films currently marketed can be used. The polarization films may be classified into a multi-halogen polarization film, a color polarization film, a metal polarization film, etc. However, the invention is not limited to these examples. In addition, any of the following polarizers may be used as the polarizer layer of the invention:

(1) a polarizer as disclosed in Japanese Laid-Open Patent Application No. 01-093702,

(2) a wire-grid polarizer in which Au or Al lines are drawn with minute gaps on a transparent substrate,

(3) a Polarcor™ glass polarizer supplied from Corning, Inc.,

(4) a lamination type polarizer proposed by Prof. Shojiro Kawakami of Electrical Communications Laboratory, Tohoku University, in 1991,

(5) a reflection type polarizer supplied from Sumitomo 3M, Inc.,

(6) a polarization beam splitter,

(7) a polarizing prism,

(8) a diffraction grating.

By piling up, combining and providing a transparent magnetic film and a polarizer layer, magnetizing a transparent magnetic film partially with a magnetic field generator, and penetrating and intercepting polarization. The magneto-optical component which made the contrast ratio discover is already proposed as in Japanese Patent No. 3626576, Japanese Patent No. 3628859, and Japanese Patent No. 3672211.

According to this invention, the magneto-optical component for which the contrast ratio increased sharply can be offered now to the invention of these former by using the titania nanosheet which is a transparent magnetic material which has many features of the following which was not in the former as a magnetic film.

For example, about visible light transmittance, in order for the conventional rare earth iron garnet to fall rapidly on the wavelength of 500 nm or less, it did not become water-white. For this reason, although it could not but become what was colored yellow as an indicating element, when the transmissivity of a light region is 1-micrometer thickness in this invention, it is 80% or more and is water-white.

As mentioned above, this is the effect which used the water-soluble organic compound together with the nanosheet, for this reason is the result (high transmissivity) of being obtained. This will raise the quantity of light at the time of the light transmission at the time of using as a magneto-optical component, and a large contrast ratio will be obtained.

As shown in FIG. 3, the nanosheet which improved sharply when periodical structure is formed and a refractive index uses from about 3.0 and about 2, such as the conventional rare earth iron garnet, the refractive index ratio within a field could improve, a larger Faraday rotation angle can be acquired now, and the large contrast ratio which is not in the former too will be obtained.

The angle of rotation to 530 nm light of the Bi substitution iron garnet according to the related art was about 7 degrees/micrometer. In contrast, the angle of rotation to 530 nm light of the nanosheet of this invention was several tens of degrees/micrometer showing a sharp increase, as a result of raising the transparency and the arrangement feature, as mentioned above.

In the magneto-optical component of this invention, it is good to consider it as the multilayer structure which laminated the magnetic film and the dielectric film, such as SiO2 whose refractive index is smaller than the magnetic film.

The specific inductive capacity of the titania nanosheet of this invention is about 125 which is 1.7 times larger than 75 of titanium oxide. However, when it is laminated using the layer by layer approach to a thickness of 100 nm (¼ of 400 nm of the shortest visible light), any practical transparent film was not obtained.

When the film formation system of this invention was used, dielectric multilayer structure was acquired using this high dielectric, and increase of the Faraday rotation angle by the multipath reflection of light was attained.

Next, two examples of compound transparent magnetic layer) will be given below, and the following examples differ from the previous examples in using the nanosheets as a high refraction film.

The 1st compound transparent magnetic layer has the lamination structure of {(GM)n(MG)n}m, where G denotes a dielectric layer, M denotes a magnetic layer, and n and m denote the number of repetitions of the layers. As for dielectric layer G and magnetic layer M, the laminating order is reversed like MG following GM. That is, it is necessary that the structure is symmetrical about magnetic layer M. Usually, the number n is in a range of 1-40 and the number m is in a range of 1-40.

The optical film thickness (n×d) is equivalent to ¼ of the wavelength. In this case, the refractive index of dielectric layer G is smaller than magnetic layer (nanosheet) M. Because there was no transparent magnetic substance which has a large refractive index conventionally, it was able to use only in a reverse combination. Because a refractive index difference larger than before can be given according to the nanosheet of the invention, it is possible to obtain a larger Faraday rotation angle than before.

The 2nd compound transparent magnetic layer is a modification of the 1st compound transparent magnetic layer in which the layer G is formed by two layers, a high refractive index layer and a low refractive index layer. The material used for the dielectric film when using a dielectric film for the layer (magnetic film) which has a magneto optic effect of this invention collectively. A stable substance is thermally transparently suitable and for example, the oxide of metal or semimetal, they are nitride, chalcogenite, fluoride, carbide, and these mixtures.

Specifically, they are simple substances or these mixtures, such as SiO₂, SiO, Al₂O₃, GeO₂, In₂O₃, Ta₂O₅, TeO₂, TiO₂, MoO₃, WO₃, ZrO₂, Si₃N₄, AlN, BN, TiN, ZnS, CdS, CdSe, ZnSe, ZnTe, AgF, PbF₂, MnF₂, NiF₂, and sic.

It is necessary to choose the material whose refractive index is smaller than a transparent magnetic layer from among these materials. Each thickness is in a range of 5-200 nm, and more preferably in a range of 5-30 nm.

A dielectric film is good also as two or more lamination, and produces a film using various kinds of PVD and CVD. The magneto-optical component in an embodiment of the invention is not necessarily used only for the display which uses the contrast ratio of transmission. It can be used for the optical isolator used from the former using a Faraday rotation angle, the optical switch for communication using an optical switch function, etc.

Specifically, it is an optical switch using the light transmittance change the case where current is sent through a magnetic coil, and at the time of sending current through an opposite direction. It is also possible to provide separately the coil as a magnetic recording medium of the system which put the coil side by side as a magnetic head, of course as a magnetic head, and to use as a magnetic recording medium of disk-like tape form.

It can also use using the above-mentioned optical switch function as an automatic modulated light window to which light transmittance is continuously changed according to current.

If a polarization conversion component is used together, it will become possible also using not as use of only an S wave or a P wave but as various optical elements using about 70% of light.

Next, some examples of the magnetic film of this embodiment will be explained.

### Example 1

Potassium carbonate (K₂CO₃), titanium dioxide (TiO₂), cobalt oxide (CoO), iron oxide (Fe₂O₃) were weighed to obtain a molar ratio of K_{0.8}Ti_{1.6}Co_{0.4}O₄ and K_{0.8}Ti_{1.2}Fe_{0.8}O₄. They were mixed and calcinated at 800 degrees C. for 40 hours, and magnetic element substitution potassium titanates (K_{0.8}T_{1.6}Co_{0.4}O₄, K_{0.8}Ti_{1.2}Fe_{0.8}O₄) was compounded.

It was made to react at room temperature, contacting the magnetic element substitution potassium titanates (K_{0.8}Ti_{1.6}Co_{0.4}O₄, K_{0.8}Ti_{1.2}Fe_{0.8}O₄) to 1 g of the particles at a ratio of 100 cm³ of hydrochloric acid 1N solution, while they were sometimes agitated.

After repeating the operation to exchange new hydrochloric acid solution day by day 3 times, the filtration and rinsing of the solid state substance was carried out, and it was air-dry. By adding 0.5 g of the obtained layered titanic acid particles (H_{0.8}Ti_{1.6}Co_{0.4}O₄ nH₂O, H_{0.8}Ti_{1.2}Fe_{0.8}O₄ nH₂O) in 100 cm³ of tetra-butyl ammonium hydroxide solution, and shaking about one week at room temperature (150 rpm), so that a milky titania sol was obtained.

The solution in which the titania sol is diluted 50 times was prepared. In this invention, H_{0.8}Ti_{1.6}Co_{0.4}O₄ nH₂O is called Co-substituted titania nanosheet, and H_{0.8}Ti_{1.2}Fe_{0.8}O₄ nH₂O is called Fe-substituted titania nanosheet. The dispersion liquid of H_{0.8}Ti_{1.6}CO_{0.4}O₄ nH₂O is called Co-substituted titania nanosheet dispersion liquid. The dispersion liquid of H_{0.8}Ti_{1.2}Fe_{0.8}O₄ nH₂O is called Fe-substituted titania nanosheet dispersion liquid.

A gelatin solution (5% by weight) which was produced by dissolving 5 g of gelatin powder to 100 g of water, and the Co-substituted titania nanosheet dispersion liquid and the Fe-substituted titania nanosheet dispersion liquid were mixed together, and the mixed dispersion liquid was prepared. Specifically, the mixed dispersion liquids in which gelatin contents are 1%, 3%, 5%, 10%, 15%, 20%, and 30% by weight respectively with respect to 10 g of each of Co-substituted titania nanosheet dispersion liquid and Fe-substituted titania nanosheet dispersion liquid were prepared. The gelatin solution (5% by weight) and each of Co-substituted titania nanosheet dispersion liquid and Fe-substituted titania nanosheet dispersion liquid were mixed and distributed using an ultrasonic distribution device.

Each dispersion liquid was applied to a cleaned quartz glass substrate using the spin coat method, and a magnetic film was produced so that its thickness after dryness may be set to about 1 micrometer, and the magnetic film was dried in the air.

As a result, the nanosheet films with the gelatin contents of 1% and 3% by weight did not show a sufficient transparency, but the nanosheet films (the Co-substituted and Fe-substituted titania nanosheet films) with the gelatin contents of 5%, 10%, 15%, and 20% by weight showed a sufficient transparency, respectively. However, in a case of the nanosheet film with the gelatin content of 30% or more by weight, the transparency improved but the Faraday rotation angle fallen, which is not desirable.

When CMC and PVA among the other water soluble polymers were used instead of gelatin and the equivalent amount was mixed, the resulting transparency was lower than in the case of gelatin regardless of the amount used. It was confirmed that the absorbance in the wavelength range of 400-800 nm of the magnetic film example with the gelatin content of 20% by weight was 0.5 or less.

### Example 2

Three kinds of dispersion liquid (the Co-substituted titania nanosheet dispersion liquid, the Fe-substituted titania nanosheet dispersion liquid, and the mixture of both the dispersion liquids (the mixing ratio: 1/1)) were prepared. Each dispersion liquid was mixed with the gelatin solution (5% by weight) so that the gelatin content relative to the nanosheet weight may be 20% by weight. Each of the mixed dispersion liquids was mixed and distributed using an ultrasonic distribution device.

Each dispersion liquid was applied to a cleaned flat quartz glass substrate using the spin coat method, and a magnetic film was produced so that its thickness after dryness may be set to about 1 micrometer, and the magnetic film was dried in the air. Thereafter, it was heated at 140 degrees C. for 10 minutes using an electric furnace.

When the film was made of the Co-substituted titania nanosheet solely, the Faraday rotation angle at the wavelength of 450 nm was about 2 degrees. When the film was made of the Fe-substituted titania nanosheet solely, the Faraday rotation angle was about 1 degree. However, it was confirmed that, if the mixed dispersion liquid was applied to form the film, the Faraday rotation angle was about 6 degrees, which showed a sharp increase.

### Example 3

The mixed dispersion liquid of Co-substituted titania nanosheet dispersion liquid and Fe-substituted titania nanosheet dispersion liquid among the three kinds of samples in the Example 2 was applied to each of five quartz glass substrates on which five kinds of different super-hydrophilization films were formed, respectively. The film was prepared and dried on each substrate similar to the Example 2.

The surface contact angles (in degrees) of the five substrates and the averages (kcounts/s) of the maximum primary diffraction peak intensity of the five substrates by X-ray diffractometry were as follows.

(Substrate 1): 4 degrees, 89 kcounts/s

(Substrate 2): 7 degrees, 74 kcounts/s

(Substrate 3): 10 degrees, 70 kcounts/s

(Substrate 4): 14 degrees, 12 kcounts/s

(Substrate 5): 19 degrees, 3 kcounts/s

As a result, it was confirmed that, when the surface contact angle of the substrate to the water was larger than 10 degrees, the maximum diffraction peak intensity in the X-ray diffraction chart was small, and the Faraday rotation angle in this case was also small.

### Example 4

The grooves 11a having a periodical structure of 2 micrometers (L&S=1 micrometer/1 micrometer, the depth=1 micrometer) as shown in FIG. 3 were formed on a quartz glass substrate with 1 mm thickness using a photolithographic method. The mixed dispersion liquid (the mixing ratio: 1/1) in the Example 2 was dropped to the substrate with the grooves 11a. After it was left, it was heated at 140 degrees C. Thereafter, the nanosheet adhering to the substrate at locations other than the grooves 11a was removed using a knife.

Measurement of a Faraday rotation angle was performed. The Faraday rotation angle at the wavelength of 450 nm was about 3.3 degrees when the film was formed to a 1-micrometer thickness on a flat quartz glass substrate. However, when the film was formed on the substrate with the grooves having the periodical structure as in the Example 4, the Faraday rotation angle was increased to about 18.3 degrees.

### Example 5

While a magnetic field of 3 teslas in the average was uniformly applied (a helium-free superconducting magnet supplied from Sumitomo Heavy Industry Co., the current value: 84 A), the films were prepared from the three kinds of samples and dried as in the Example 2. The direction of application of the magnetic field was set up as being parallel to the quartz glass substrate surface.

As a result, the average (in kcounts/s) of the maximum primary diffraction peak intensities of the three samples by the X-ray diffractometry and the Faraday rotation angle (in degrees) at the wavelength of 450 nm were as follows.

(with no magnetic field applied) 30 kcounts/s, 3 degrees

(in dry state with 3-tesla magnetic field applied) 340 kcounts/s, 6.7 degrees

It was confirmed that when a strong magnetic field was applied to the surface of the substrate in parallel, the maximum diffraction peak intensity in the X-ray diffraction chart was increased about 10 times and the Faraday rotation angle in that case was large. It was confirmed that when a weak magnetic field (0.5 teslas) was applied to the surface of the substrate, the improvement in the X-ray diffraction intensity was not observed.

### Example 6

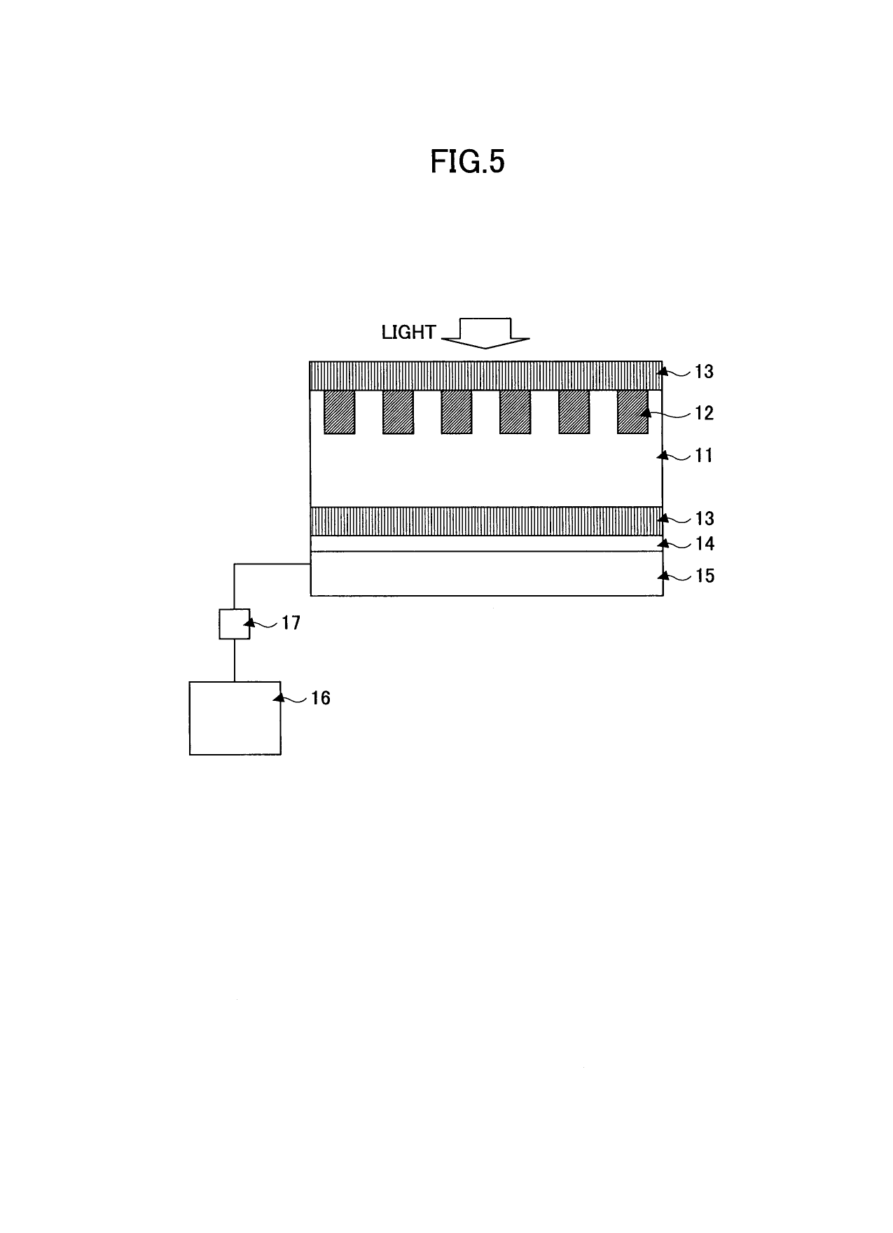

The magneto-optical component shown in FIG. 5 was prepared using the nanosheet film prepared in the Example 4. Specifically, the nanosheet film (containing the substrate 11 and the magnetic film 12) prepared in the Example 4 was sandwiched between two sheets of commercially available iodine-type polarizers 13, and a reflection film 14 of silver was formed on one side of the polarizers 13.

A magnetic coil 15 was formed by turning a copper wire with a thickness of 25 micrometers 150 times so that the outside length was 14 mm. The magnetic coil 15 was arranged on a surface of the reflection film 14 opposite to the nanosheet film, and a direct current from a power supply 16 was supplied to the magnetic coil 15 by controlling ON/OFF of a switch 17. It was confirmed that the light entering the magneto-optical component was turned from white to black and vice versa according to ON and OFF of the supplied current. The contrast ratio was 23.

### Example 7

The mixed nanosheet liquid of the Co and Fe mixing ratio 1/1 prepared in the Example 2 was applied to a quartz substrate of 0.1 mm thickness using the spin coat method, and the film was formed so that the optical thickness may be set to 450 nm/4. Thereafter, it was heated at 140 degrees C. Next, a commercially available silica aerosol (in which ultra-fine silica particles with nanometer-order diameters are distributed in water; the product of Nippon Chemical Industrial Co.) was applied to the film and the film with the silica aerosol was formed so that the optical thickness may be set to 450 nm/4.

Subsequently, the lamination of the nanosheets/the silica aerosol was repeated 6 times in the same manner. The Faraday rotation angle at the wavelength of 450 nm of the sample in which only the nanosheets were applied to the quartz glass substrate 6 times was about 3.3 degrees, but the Faraday rotation angle of the sample having the periodical structure film was about 18.3 degrees, showing a sharp increase.

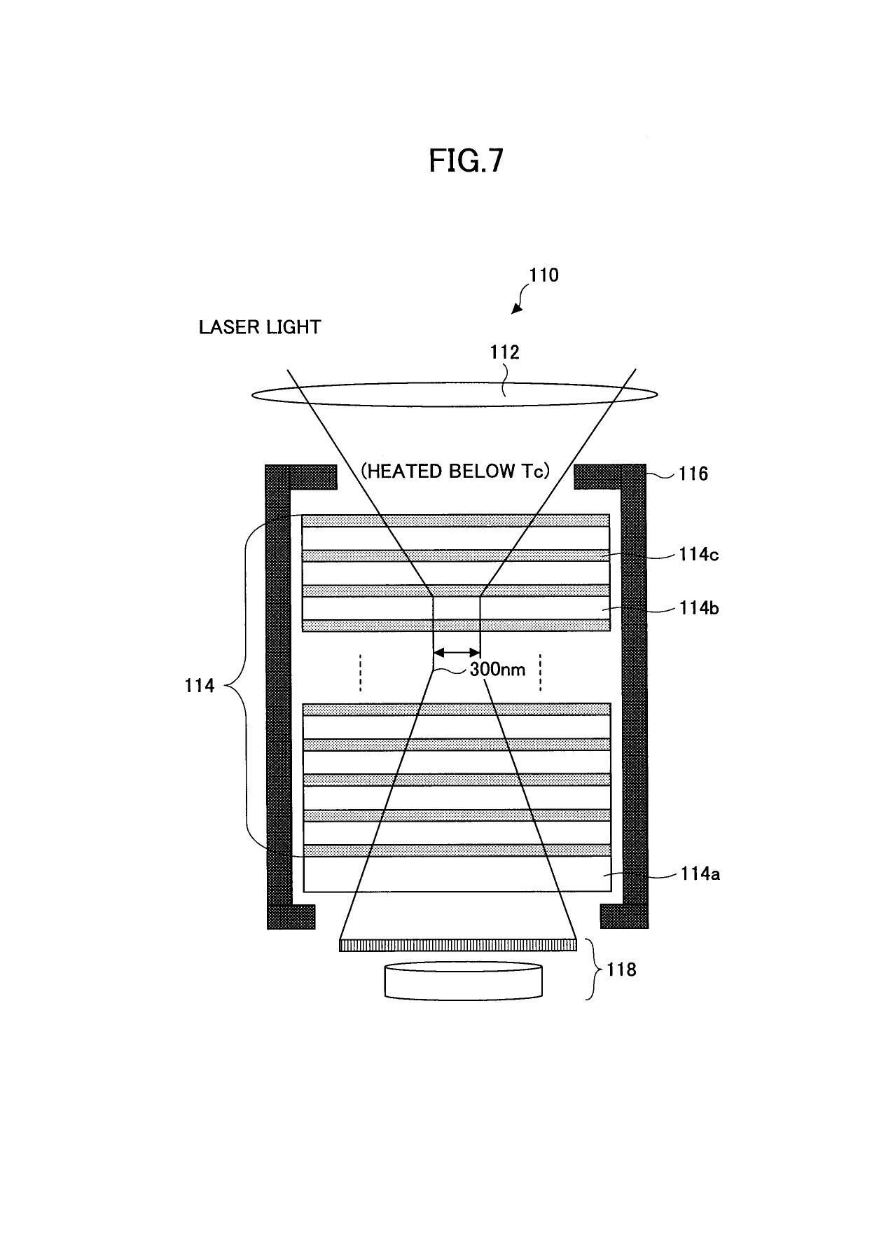

Next, FIG. 7 shows the composition of a magnetic recording/reproducing device in an embodiment of the invention.

As shown in FIG. 7, the magnetic recording/reproducing device 110 in this embodiment includes: a light source (which is not illustrated); a light converging unit 112; a lamination film 114 which contains titania nanosheets 114b and polymer layers 14c, provided on a transparent substrate 114a; a magnet 116 (which is a magnetic field applying unit); and a rotation angle measuring instrument 118.

In this embodiment, a gas laser, a semiconductor laser, a white light source, etc. may be used for the light source of the magnetic recording/reproducing device 110.

The light converging unit 112 is a condenser optical system which uses a convex lens as shown in FIG. 7. It is preferred to use a convex lens having a large numerical aperture (NA), such as 0.85.

It is preferred to use the method used in a confocal microscope for this condenser optical system. In a confocal microscope, a laser beam is passed through an objective lens and a fluorescent light beam is generated so that a sample is illuminated and scanned with a very small light spot to form an image. The fluorescence flare (fluorescence before and behind the observation point) produced before and behind the spot can be removed by the action of a pinhole, only the luminescence at the spot can be detected to observe the sample.

For example, the scanned type confocal microscope using the optical system dedicated for 408 nm (optical devices for ultraviolet lights) is commercially available. With this microscope, the aberration which is likely to arise in a short wavelength light source can be suppressed. A high resolution can be obtained by using the confocal optical system having the optimized circular pinhole adopted, and the high-speed XY scanner utilizing the MEMS technology. As plane resolution, a 0.12-micrometer line and space can be recognized certainly, and a height resolution of 0.01 micrometers is obtained.

The lamination film 114 contains the titania nanosheets 114b and the polymer layers 114c formed on the transparent substrate 114a.

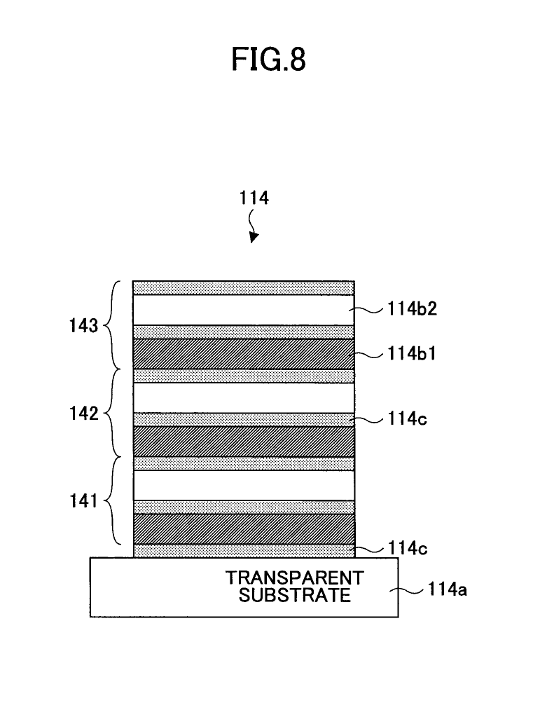

FIG. 8 shows an example of the lamination film 114. In this lamination film 114, a set of unit lamination films 141 to 143 are laminated on a transparent substrate 114a. In each of the unit films 141 to 143, an Fe substitution titania nanosheet 114b1 and a Co substitution titania nanosheet 114b2 are sandwiched between polymer layers 14c.

In order to form a uniform lamination film 114, it is important to form a polymer layer 114c directly on the transparent substrate 114a beforehand. This enables the lamination film 114 to show a high transparency and a large faraday rotation angle.

In a case of the example of FIG. 8, the lamination of ten layers of titania nanosheets results in a thickness of about 10 nm. For example, when a 300 nm laser beam is focused on the titania nanosheet with the spot diameter of 300 nm and the laser light energy is absorbed to heat the titania nanosheets, a faraday rotation angle in this case is about 30 degrees/micrometer. If applying a laser bean to 15 layers of titania nanosheets and heating them is made the recording unit, a faraday rotation angle becomes 0.45 degrees.

The titania nanosheet according to this invention which is useful as a transparent magnet is used for each of the titania nanosheets 114b1 and 114b2 (which are collectively called titania nanosheets 114b). Each titania nanosheet 114b contains a layered titanium oxide in which at least one magnetic element is substituted for a Ti lattice position, the titanium oxide being expressed by the formula: Ti₂₋ₓMₓO₄ where M is at least one kind of transition metal elements chosen from among V, Cr, Mn, Fe, Co, Ni, and Cu, and 0<x<2.

As for the polymer layer 114c to be laminated with the titania nanosheet 114b, any of polydimethyldiallyl ammonium chloride (PDDA), polyethylene imine (PEI), hydrochloric acid poly allylamine (PAH), etc. is used preferably. The titania nanosheet layering method is disclosed in the manufacturing method of a super-thin film titania (see Japanese Laid-Open Patent Application No. 2001-270022).

As the material of the transparent substrate 114a, any of transparent ceramic materials, such as silica glass, GGG (gadolinium gallium garnet), sapphire, lithium tantalate, crystallization transparent glass, Pyrex (registered trademark) glass, single crystal silicon, Al₂O₃, Al₂O₃—MgO, MgO—LiF, Y₂O₃—LiF, BeO, ZrO₂, Y₂O₃, ThO₂, CaO, and inorganic materials, such as inorganic silicon, may be used. Moreover, any of organic materials, such as MMA, PMMA, ABS resins, polycarbonate, polypropylene, acrylic system resin, styrene resin, polyarylate, polysulfone, polyether sulfone, epoxy resin, poly-4-methylpentene-1, fluorinated polyimide, fluororesin, phenoxy resin, polyolefine system resin, and Nylon resin may be used. The thickness of the transparent substrate 114a is preferably in a range of 10-100 micrometers.

For this invention, the surface accuracy and the parallelism of the transparent substrate 114a are important. The surface accuracy is expressed by the difference between the highest surface accuracy part and the lowest surface accuracy part in the whole effective plane. For example, when a measurement wavelength (λ) is 632.8 nm, in the case of the surface accuracy λ/10, the difference between the highest part and the lowest part in the whole effective plane is 63.28 nm.

The parallelism of the transparent substrate 114a is the inclination of the opposite surface of the substrate to one surface of the substrate which is set up as a reference surface. When the substrate is used as a transmission type such as an aperture plate, it must be a parallel planar substrate with double-sided accuracy surfaces and its parallelism must be less than 5 seconds. When the substrate is used as a reflection type such as a mirror plate, it must be a planar substrate with a one side accuracy surface and its parallelism must be less than 3 minutes.

It is necessary that the rotation angle measuring instrument 118 for the plane of polarization used in this embodiment is capable of detecting a smallest possible angle of rotation. For example, the rotation angle measuring instrument 118 must have about 0.01-degree angular resolution. A commercially available evaluation system may be used as the rotation angle measuring instrument 118. For example, an ultraviolet spectroscopy type magneto optic effect measuring apparatus (BH-M800V) from Neoarc Co. may be used preferably, and it has about 0.001-degree angular resolution.

There are two important points for the above-described magnetic recording/reproducing device of this embodiment. The first point is to use the lamination film 114 containing the titania nanosheets 114b and the polymer layers 114c for magnetic recording and reproduction. It is also important for the magnetic recording/reproducing device of this embodiment to incorporate the magnetic field applying unit 116 which includes a magnetic coil or permanent magnet. Simultaneously with the time of laser heating or invariably, the magnetic field applying unit 116 applies a magnetic field, which is less than about the coercive force of the titania nanosheets 114b, to the titania nanosheets 114b in a direction perpendicular to the surface of the titania nanosheets 114b.

Since the coercive force of the titania nanosheet 114b is declined at the time of heating, it is possible to carry out magnetic recording (facing magnetization upward or downward) with the applied magnetic field at the level of several tens of gausses. Furthermore, the use of a laser beam is most desirable because the laser beam is able to penetrate the lamination film 114 to record information at an arbitrary point of the magnetic substance (the titania nanosheet 114b). Moreover, the laser beam heats the magnetic substance to reduce the coercive force, and it is useful for miniaturizing a magnetic field generator (the magnetic field applying unit 116).

At a time of reproduction, the laser beam is made enter the titania nanosheets 114b at right angles, and it is detected whether the angle of rotation of the plane of polarization is in the + direction or the − direction by using the rotation angle measuring instrument 118.

An LD or LED which generates a linearly polarized laser beam may be used as a light source of a laser beam for reproduction. In a case of using a laser light source which emits a circularly polarized light ray, a polarizer may be attached to the laser light source so that the circularly polarized light ray is converted into a linearly polarized light ray by the polarizer, and the light ray output from the polarizer enters the titania nanosheets 114b.

The second important point for the magnetic recording/reproducing device of this embodiment is that it must have a height resolution of 10 nm.

The magnetic recording/reproducing device 110 of this embodiment is able to perform recording and reproducing information at an arbitrary layer in the multilayer structure in the lamination film of several tens of layers, such as 50 layers, by the combination of the first and the second important points.

It is preferred that the laser wavelength for recording, used in the magnetic recording/reproducing device 110, is a relatively short wavelength less than 400 nm (ultraviolet light wavelength) in view of the absorbance characteristics of the titania nanosheets 114b. With the use of this wavelength, the heat absorptivity at the time of recording can be increased and the diameter of a recording bit can be reduced, which is suitable for high density recording.

It is preferred that the laser wavelength for reproduction, used in the magnetic recording/reproducing device 110, is a relatively long wavelength larger than 400 nm (visible light wavelength). Specifically, a wavelength at the peak of the wavelength dependency is desired.

With the use of the laser wavelengths for recording and for reproduction, the faraday rotation angle by the titania nanosheets 114b can be increased and the detection sensitivity can be improved. However, if the ratio of the reproduction wavelength to the recording wavelength is too large, a difference in the irradiation surface area of the laser beam may occur and a cross talk (the influence of neighboring bits) may occur. Hence, the ratio is determined in accordance with the relation to the intended recording density. Specifically, the ratio in a range of 1/1-2/1 is desired.

It is preferred that the lamination film 114, used in the magnetic recording/reproducing device 110, includes two or more kinds of titania nanosheets 114b which have a different wavelength dependency of the faraday rotation angle. This enables the reproducing from a specific lamination film arbitrarily selected from among a set of lamination films.

The wavelength dependency in the faraday rotation angle of a titania nanosheet 114b is variable in accordance with the kind of substitution magnetic element, the amount of substitution magnetic element, or the number of kinds of substitution magnetic elements in the titania nanosheet 114b.

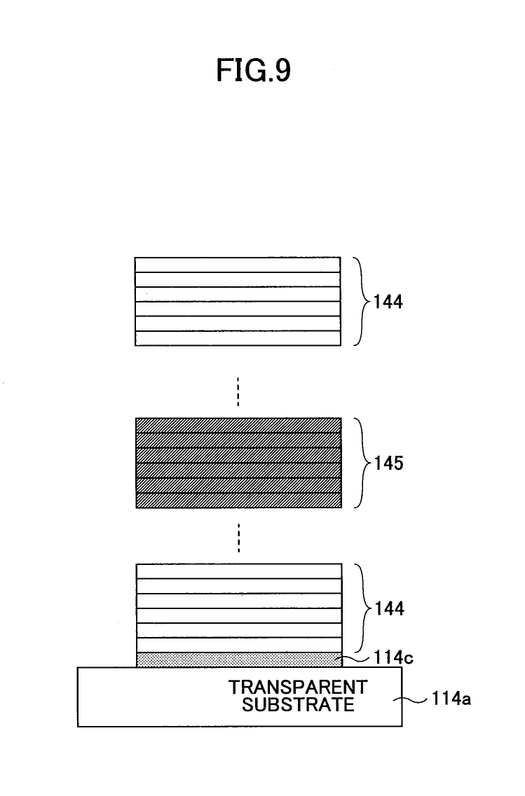

For example, FIG. 9 shows the lamination structure of a lamination film 114 including different kinds of nanosheets for use in the magnetic recording/reproducing device of the invention. As shown in FIG. 9, the lamination film 114 includes a set of titania nanosheet groups 144 and a set of titania nanosheet groups 145 which are laminated on a transparent substrate 114a via a polymer layer 114c. Each titania nanosheet group 144 forms the unit thickness (recording unit) of the lamination film 114 and has titania nanosheets 114b of the kind A laminated. Each titania nanosheet group 145 forms the unit thickness (recording unit) of the lamination film 114 and has titania nanosheets 114b of the kind B laminated. The titania nanosheets 114b of the kind A and the titania nanosheets 114b of the kind B differ in the wavelength dependency of the faraday rotation angle.

If one of the laser beam wavelengths (corresponding to the kinds A and B respectively) is selected at the time of reproduction, the layer where the information is reproduced by the magnetic recording/reproducing device can be selected from among the titania nanosheet groups 144 and titania nanosheet groups 145. In addition, simultaneous reproduction with multiple wavelengths is also possible. It is also possible to additionally insert an intermediate layer, which is transparent and nonmagnetic and has good heat insulation, between the above-mentioned recording units in the lamination film.

It is preferred that the lamination film 114, used in the magnetic recording/reproducing device 110, includes two or more kinds of titania nanosheets 114b which differ in the wavelength dependency of absorbance. This enables the layer where the information is recorded by the magnetic recording/reproducing device to be chosen and heated.

The wavelength dependency in the absorbance of a titania nanosheet 114b is variable in accordance with the kind of substitution magnetic element, the amount of substitution magnetic element, or the number of kinds of substitution magnetic elements in the titania nanosheet 114b. Therefore, with the use of the lamination film in which two or more kinds of titania nanosheets each having a certain thickness as the unit thickness (the recording unit) are laminated, if one of the laser beam wavelengths is selected at the time of recording, the layer where the information is recorded by the magnetic recording/reproducing device can be selected from among the titania nanosheets. In addition, simultaneous recording with multiple wavelengths is also possible.

It is also possible to vary the wavelength dependency in the absorbance of a polymer layer 114c. However, in this case, a difficulty in matching of the polymer layer 114c with the titania nanosheet 114b may occur (the titania nanosheet has negative electricity and the polymer layer selection is very restricted), and varying the wavelength dependency in the absorbance of the titania nanosheet 114b is easier than varying the wavelength dependency in the absorbance of the polymer layer 114c.

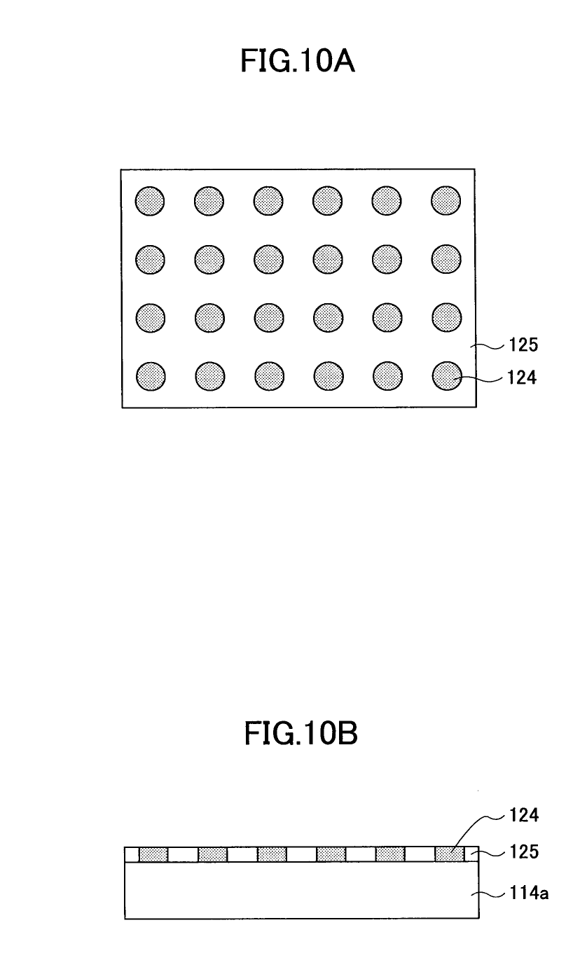

The lamination film, used in the magnetic recording/reproducing device 110 of this embodiment, may be arranged as shown in FIG. 10A and FIG. 10B. Chips 124 of this lamination film are discontinuously arranged in a two-dimensional formation in a supporting substrate 125 and the supporting substrate 125 is formed on a transparent substrate 114a. Each chip 124 has a laminated structure containing titania nanosheets of the material which is the same as that of the above-mentioned titania nanosheet 114b, and polymer layers of the material which is the same as that of the above-mentioned polymer layer 114c.

With the use of the above-described lamination film, restriction of the recording position is possible, recording information in a smaller area than the diffraction limit of a laser beam is possible, and high density recording may be attained.

For example, when recording is performed using ultraviolet light with a wavelength of 300 nm, the diameter of a recording bit is set to about 300 nmφ. Using this method, the diameter of a recording bit may be set to 100-200 nmφ. High density recording may be attained.

As a typical manufacturing method which produces a two-dimensional arrangement of the chips 124 of the lamination film of titania nanosheets and polymer layers, the following method may be used. Recesses and lands are regularly formed on a supporting substrate, and then chips of a lamination film containing titania nanosheets and polymer layers are formed in the recesses of the supporting substrate. Alternatively, another method may be used in which a continuous film is first deposited on the supporting substrate and then the chips are formed by using the etching method using gas, etc. Alternatively, micro pores (with a diameter of several tens of nanometers) may be formed on a disk-like plate of aluminum.

In the magnetic recording/reproducing device 110 of this embodiment, it is preferred to integrate a laser light source, a light converging unit 112, a magnetic field applying unit 116, and a rotation angle measuring instrument 118 into a unified module. And it is preferred that the recording/reproducing part of the lamination film 114 is changed by a relative movement of the unified module and the lamination film 114.

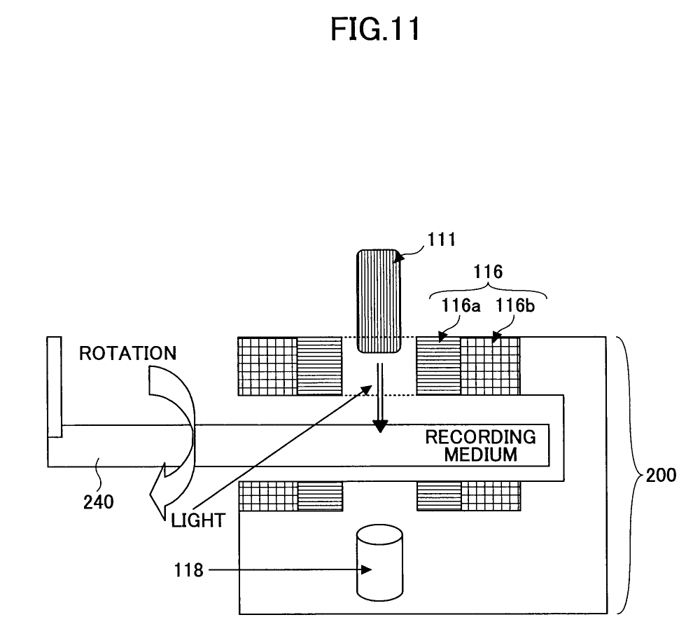

FIG. 11 shows the composition of a recording/reproducing head in which a laser light source, a light converging unit, a magnetic field applying unit, and a rotation angle measuring instrument are integrated. As shown in FIG. 11, a laser light source 111, a light converging unit (not shown), a magnetic field applying unit 116, and a rotation angle measuring instrument 118 are unified as a recording/reproducing head 200, and the recording/reproducing part of the lamination film 114 is changed by moving a magnetic recording medium 240, containing the lamination film 114, relative to the recording/reproducing head 200.

The composition in FIG. 11 is realized by the miniaturization of the magnetic field applying unit 116. The size of the magnetic field applying unit 116 is reduced remarkably because the thickness of the entire lamination film 14 can be small, the recording part of the lamination film 14 can be small, the thermal efficiency of the recording can be high, and the coercive force is lowered by the heating unit. In this case, it is preferred that a guide line for positioning the head at the time of recording or reproduction is formed in the magnetic recording medium 240, which will be effective in obtaining a high S/N ratio.

It is preferred that the rotation angle measuring instrument 118, used in the magnetic recording/reproducing device 110, is a polarization detector in which a titanium oxide film and a thin film of conjugate polymer orientation are combined. This enables the lamination structure of a thin film to be formed and enables the magnetic recording/reproducing device of this embodiment to be compact.

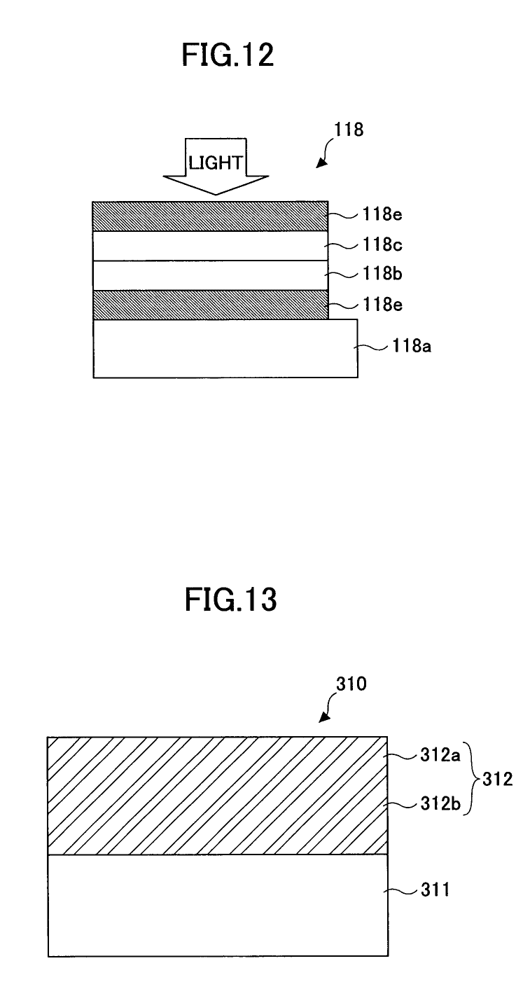

FIG. 12 shows the composition of the rotation angle measuring instrument mentioned above. As shown in FIG. 12, this laminate rotation angle measuring instrument 118 is constructed by depositing an electrode 118e, a polymer orientation film 118b, a titanium oxide film 118c, and an electrode 118e on a substrate 118a in this order.

In this embodiment, the titanium oxide film 118c is formed with a thickness of about 200 nm by using a sputtering method. The polymer orientation film 118b is formed from a conjugate polymer which is any of polyphenylene, polythiophene, polyphenylenevinylene, polysilane, and their derivatives by using heat conversion of a conjugate polymer (see Japanese Patent No. 3694738).

The mechanism for generating the electromotive force in the rotation angle measuring instrument 118 is as follows. For example, polyparaphenylene vinylene (PPV) molecules are excited by light irradiation, and the excited molecules are formed in the thin film 118b. Next, charge separation arises at the interface between the thin film 118b and the titanium oxide film 18c, electrons move to the anode while electron holes move to the cathode, so that the optical voltage arises and the optical current occurs.

At this time, in the case of a polarized light ray parallel to the sweeping direction of heat conversion, the absorptivity of light energy is high and many excited molecules are generated. For this reason, an optical voltage higher than in the case of a polarized light ray perpendicular to the sweeping direction of heat conversion occurs, and a difference between the plane of parallel polarization and the plane of perpendicular polarization is clearly detectable.

The polarization detector (the rotation angle measuring instrument 118) in which the titanium oxide and the thin film of conjugate polymer orientation are combined is capable of detecting a plane of polarization without using a polarizer. If a laser device which generates a polarized light ray for recording is used together, it is no longer necessary to use a polarizer. The absorption and reflection of light by a polarizer can be eliminated, and the light use efficiency improves remarkably. Accordingly, the detection sensitivity improves.

Next, some examples of the lamination film used in the magnetic recording/reproducing device of this embodiment will be explained.

### Example 1

First, a lamination film which contains titania nanosheets and polymers was formed as follows.

Potassium carbonate (K₂CO₃), titanium dioxide (TiO₂), cobalt oxide (CoO), and iron oxide (Fe₂O₃) were weighed to obtain a molar ratio of K_{0.8}Ti_{1.4}Fe_{0.2}Co_{0.3}O₄. It was mixed and calcinated at 800 degrees C. for 40 hours, and magnetic element substitution potassium titanate (K_{0.8}Ti_{1.4}Fe_{0.2}Co_{0.3}O₄) was compounded.

Subsequently, it was made to react at room temperature by contacting the compound magnetic element substitution potassium titanate (K_{0.8}Ti_{1.4}Fe_{0.2}Co_{0.3}O₄) to hydrochloric acid 1N solution at a ratio of 100 cm³ to 1 g of particles, and it was sometimes agitated.

After repeating the operation exchanging the solution by new hydrochloric acid solution day by day 3 times, the filtration and rinsing of the solid state substance was carried out, and it was air-dry.

0.5 g of the obtained layered titanic acid particles (H_{0.8}Ti_{1.4}Fe_{0.2}Co_{0.3}O₄ nH₂O) was added to 100 cm³ of tetra-butyl-ammonium hydroxide solution, and it was shaked for one week at room temperature (150 rpm) to obtain a milky titania sol.

The solution in which the titania sol is diluted 50 times, and 2 wt % of poly-dimethyl-diallyl-ammonium (PDDA) chloride solution were prepared, and the pH was adjusted to nine.

The sheet containing H_{0.8}Ti_{1.4}Fe_{0.2}Co_{0.3}O₄ nH₂O is called Co—Fe simultaneous substitution nanosheet. The dispersion liquid of H_{0.8}Ti_{1.4}Fe_{0.2}Co_{0.3}O₄ nH₂O is called Co—Fe-substituted titania nanosheet dispersion liquid.

As a substrate, a quartz glass plate with the surface area of 5 cm×1 cm whose surface accuracy is λ/20 and whose plane parallelism is 5 seconds was used. After the quartz glass plate was washed by 2% solution of Merck ExtranMA02, it was immersed in concentrated sulfuric acid and next in 1:1 solution of methanol and concentrated hydrochloric acid.

Subsequently, after 30 minutes, it was taken out from the solution and fully washed by Milli-Q pure water. Next, this substrate was immersed for 20 minutes in a solution of 0.25 wt % of polyethyleneimine and fully washed by Milli-Q pure water.

The substrate after the washing and the pretreatment were performed was subjected to the following steps: (1) it was immersed in the titania sol solution; (2) after 20 minutes, it was fully washed by Milli-Q pure water, sprayed by the argon air flow and made to dry; (3) the substrate is immersed in the PDDA solution for 20 minutes, and (4) continuously, it was fully washed by Milli-Q pure water. By repeating the above steps (1) to (4), the titania nanosheet lamination object was formed.

Subsequently, a coil 116b was formed by winding a copper wire around a magnetic core (core) 116a which is made of permalloy, as shown in FIG. 11. The magnetic field applying unit 116 in which the magnetic core 116a and the coil 116b are unified was prepared, and the magnetic field applying unit 116 was arranged so that the titania nanosheet lamination object (recording medium) may be interposed between the upper part and the lower part of the magnetic field applying unit 116. A through hole was formed in the center of the magnetic core so that a laser beam can pass through the magnetic core.

Next, using the optical recording and reproducing device which was prepared by modifying the confocal microscope to set the laser beam wavelength to 300 nm, the upper ten layers of the titania nanosheet lamination object were selected as the recording unit, and the focal point of the laser beam was selected, so that the applied heat was absorbed by the titania nanosheet lamination object while the magnetic field (50 Oe) was applied to the recording-medium in the up orientation to carry out thermo-magnetic recording. Moreover, the radiation position of the laser beam was moved, and thermo-magnetic recording was continued. The direction of the magnetic field was arbitrarily changed in the up orientation or the down orientation. The irradiation surface area of the laser beam was about 300 nm.

Subsequently, using the laser beam with a wavelength of 520 nm, the upper ten layers of the titania nanosheet lamination object were similarly selected as the recording unit, and the focal point of the laser beam was chosen, and the rotation angle was measured using the rotation angle measuring instrument (or the faraday rotation angle measuring apparatus) 118 in order to inspect the direction of spin orientation of the recording part.

It was confirmed that when the recording direction (direction of magnetization) of each recording unit for every ten layers is the up orientation, a positive value of the rotation angle was detected, and when the recording direction was the down orientation, a negative value of the rotation angle was detected.

### Example 2

The lamination film which contains titania nanosheets and polymers was formed as follows.

Potassium carbonate (K₂CO₃), titanium dioxide (TiO₂), cobalt oxide (CoO), and iron oxide (Fe₂O₃) were weighed to obtain a molar ratio of K_{0.8}Ti_{1.6}Co_{0.4}O₄ and K_{0.8}Ti_{1.2}Fe_{0.8}O₄, and they were mixed and calcinated at 800 degrees C. for 40 hours, so that magnetic element substitution potassium titanates (K_{0.8}Ti_{1.6}Co_{0.4}O₄, K_{0.8}Ti_{1.2}Fe_{0.8}O₄) were compounded.

It was made to react at room temperature, by contacting the magnetic element substitution potassium titanates (K_{0.8}Ti_{1.6}Co_{0.4}O₄, K_{0.8}Ti_{1.2}Fe_{0.8}O₄) to 1 g of particles at a ratio of 100 cm3 of hydrochloric acid 1N solution, and sometimes agitated.

After repeating the operation exchanged in hydrochloric acid solution new day by day 3 times, the filtration and rinsing of the solid state substance was carried out, and it was air-dry.

0.5 g of the obtained layered titanic acid particles (H_{0.8}Ti_{1.6}Co_{0.4}O₄ nH₂O, H_{0.8}Ti_{1.2}Fe_{0.8}O₄ nH₂O) was added to 100 cm³ of tetra-butyl-ammonium hydroxide solution, and it was shaked for one week at room temperature (150 rpm) to obtain a milky titania sol. The solution in which it is diluted 50 times, and 2 wt % of poly-dimethyl-diallyl-ammonium (PDDA) chloride solution were prepared, and the pH was adjusted to 9.

Hereafter, the sheet containing H_{0.8}Ti_{1.6}Co_{0.4}O₄ nH₂O is called Co-substituted titania nanosheet, and the sheet containing H_{0.8}Ti_{1.2}Fe_{0.8}O₄ nH₂O is called Fe-substituted titania nanosheet.

Similar to the Example 1, the concentrated sulfuric acid after Merck ExtranMA02 2% liquid washes a quartz glass plate (5 cm×about 1 cm), and subsequently to 1:1 solution of methanol and concentrated hydrochloric acid, it was immersed.

It took out from the solution after 30 minutes, and Milli-Q pure water fully washed. Next, this substrate was immersed for 20 minutes into concentration 0.25 wt % of polyethylene imine solution, and Milli-Q pure water fully washed.

Thus, the substrate for which washing and pretreatment were performed was subjected to the following.

(1) it was immersed in the PDDA solution for 20 minutes, and the layer of PDDA was formed.
(2) it was immersed in the Co-substituted titania nanosheet solution.
(3) the Milli-Q pure water fully washes after 20-minute progress, and the argon air flow was sprayed and it was made to dry.
(4) this substrate is immersed in the PDDA solution for 20 minutes.
(5) the Milli-Q pure water fully washed.

Subsequently, it was immersed in Fe-substituted titania nanosheet solution, class formation was repeated a total of 10 times 5 times respectively in order of Co/Fe/Co/Fe, and a 50-layer record layer was formed.

When the wavelength dependency of the faraday rotation angle of the Co and Fe-substituted titania nanosheet lamination object was measured, the peak wavelength was in about 450 nm, and it was rotation angle zero in 520 nm.

Subsequently, formation of 50 layers of CoFe simultaneous substitution nanosheets was performed like the Example 1.

When the wavelength dependency of the faraday rotation angle of a CoFe simultaneous substitution nanosheet lamination object was measured at this time, comparatively evenly and on the whole, it was large. For the wavelength of 520 nm, it was 15 degrees/micrometer.

Subsequently, the ten-layer layered product in which (Co/Fe) is repeatedly formed and ten layers of CoFe simultaneous substitution nanosheet layered product are laminated one by one in the sequence of (Co/Fe)/(CoFe simultaneous substitution)/(Co/Fe)/(CoFe simultaneous substitution). The layered product of a total of 500 layers was formed repeatedly a total of 50 times 25 times respectively.

When reproducing after performing laser record like the Example 1 and the laser beam wavelength was performed at 450 nm and 520 nm, the recording direction for every record unit was able to check more clearly than the Example 1.

### Example 3

In the absorbance of the CoFe simultaneous substitution titania nanosheet formed in the Example 2, the peak was accepted in 260 nm.

In the absorbance of the layered product (Co-substituted titania nanosheet/Fe-substituted titania nanosheet), the peak was accepted in 340 nm.

Then, after recording the wavelength in the case of carrying out optical record on each record unit as 260 nm and 340 nm, when the recording direction (direction of a spin) of each record unit was investigated like the Example 1, the number of laminations of each class was able to detect at least five layers at a time.

### Example 4

A hole 200 nm in diameter and 100 nm in depth as shown in FIG. 10A and FIG. 10B using the photolithography method was provided on the glass substrate in a cycle of 300 nm.

After performing processing which forms a titania nanosheet and one layer of films of PDDA at a time like the Example 1 on this glass substrate, the film formed in addition to the hole was shaved off mechanically.

As the length of the CoFe simultaneous substitution product in this case and a horizontal size were set to 100 nm or less, they were produced. Applying a three-tesla magnetic field to the glass substrate is continued so that it may become parallel to a substrate side, and it was made for a titania nanosheet to laminate in parallel with a substrate side.

It carried out by having repeated this processing and the thing of a total of 50 layers was formed as a lamination structure of the CoFe simultaneous substitution product.

In the Example 1, although the irradiation surface product of the laser beam was about 300 nmφ, when it considered it as the recording medium of the above composition, it was able to decrease the irradiation surface product with 200 nmφ, and was able to record it with high density.

### Example 5

In the faraday rotation angle measuring apparatus of the Example 1, since the direction of rotation of the plane of polarization was reversed by being magnetized facing up or downward for every record part, when the passing surface of the polarizer was fixed to either, the direction of rotation was detectable by measuring the light intensity to pass.

However, since the highly precise polarizer is expensive, its method of not using a polarizer is desirable. Then, when the polarization detector which combined the orientation thin film of titanium oxide and a conjugate polymer is formed in the position shown in FIG. 11 using the laser light source which generates polarization, it is, Only the layered product of the thin film was able to be used for high sensitivity, without using a polarizer, the magnetizing direction could be detected, and it was able to be considered as the super-high-density magnetic recording/reproducing device miniaturized sharply.

Next, a description will be given of a polarization conversion component in an embodiment of the invention.

The polarization conversion component in this embodiment is arranged to form a structural birefringence layer having a repetition pattern with a periodically changing density in a slanting direction to the substrate by using a magnetic substance and an organic substance. See FIG. 13.

Specifically, a polarization conversion component 310 in this embodiment includes a lamination film 312 formed on a surface of a substrate 311 with a given inclination angle to the surface of the substrate 311, the lamination film 312 having an alternate lamination of transparent magnetic layers 312a. Each transparent magnetic layer 312a containing a layered titanium oxide in which at least one magnetic element is substituted for Ti lattice positions, the titanium oxide being expressed by a formula: Ti₂₋ₓMₓO₄ where M is at least one kind of transition metal elements chosen from among V, Cr, Mn, Fe, Co, Ni, and Cu, and 0<x<2.

The lamination film 312 has a layered structure in which a density of the lamination film 312 changes to the substrate 311 periodically and slantingly based on a difference in density between the transparent magnetic layers 312a and the transparent organic layers 312b to form a birefringence.

The magnitude of density here is used in the same meaning as the size of a refractive index. Although a transparent magnetic substance is used as a high-density material, it is a transparent magnetic substance, i.e., a high refractive index material. The portion with low density is a portion to which it is the void at the time of using the conventional oblique deposition method, or density is falling for void.

It is also possible to use a polymeric material for low density, i.e., a low-refractive-index portion. A refractive index is expressed by the formula: εμ^{1/2} (where ε is a dielectric constant and μ is a permeability). That is, a high refractive index is obtained by material with large dielectric constant and permeability.

A high refractive index is obtained from the magnetic material mainly used by this invention having a dielectric constant as large as the twice about of titanium oxide. For this reason, since the slanting orientation film used for polarized light separation will have large refractive index anisotropy, the large value which does not have two polarized-light-separation angles in the former is acquired.

Examples of the material of the substrate 311 may include inorganic materials, such as inorganic silicon and transparent ceramic materials, including silica glass and GGG (gadolinium gallium garnet), sapphire, lithium tantalate, crystallization transparent glass, Pyrex (registered trademark) glass, single crystal silicon, Al₂O₃, Al₂O₃—MgO, MgO—LiF, Y₂O₃—LiF, BeO, ZrO₂, Y₂O₃, ThO₂, CaO.

The transparent magnetic layer 312a may be formed by a polycrystal film, or a slanting lamination of sheet-like thin films. The material of the transparent magnetic layer 312a of the invention may be a ferromagnetic material, or any of a paramagnetic substance and an antiferromagnetic substance.

Here, a ferromagnetic material is preferably used for the transparent magnetic layer 312a, and it is held while a certain specific direction had been magnetized uniformly.

In order to retain data without being erased by an external magnetic field, etc., it is preferred that a transparent magnetic substance which has a coercive force larger than about 300 Oe is used.

An indispensable condition in the case of a paramagnetic substance is that application of an external magnetic field is possible.

The transparence means that it has to be transparent to the light of a specific wavelength, preferably any one in a range of wavelength of 400-800 nm (visible light). If it is transparent to ultraviolet light, infrared light, etc., it can be used for different purposes.

In other words, it is a matter of course that the light which is usable according to this invention is not limited to visible light, but it may also be ultraviolet light or infrared light.

In this invention, the transparent magnetic layers 312a which contain a magnetic material with a large Faraday effect is used rather than a nonmagnetic substance such as a calcite or an oblique deposition film used in the related art.

As the common transparent magnetic material used for the layer which has a large Faraday effect, a material with large birefringence, such as oxides, such as Co ferrite and Ba ferrite, FeBO₃, FeF₃, YFeO₃, and NdFeO₃, MnBi, MnCuBi, PtCo, etc. may be used, and transparency is acquired (for it to combine with a dielectric film).

As an inorganic magnetic material especially with high transparency, there is TiO₂ which doped n type Zn₁₋ₓVₓO and Co.

The rare earth iron garnet expressed by the following formula (1) can be used as a transparent magnetic material which has a uniform and large figure of merit over the whole visible light. The formula (1): R₃₋ₓAₓFe_{5-y}B_{y}O₁₂ (where 0.2<x<3, 0<=y<5, R is at least one kind of rare earth metal elements chosen from among Y, Sm, Eu, Gd, Tb, Dy, Ho, Er, Tm, Yb, and Lu, and A is at least one chosen from among Bi, Ce, Pb, Ca, and Pt, and B is at least one chosen from among Al, Ga, Cr, Mn, Sc, In, Ru, Rh, Co, Fe(II), Cu, Ni, Zn, Li, Si, Ge, Zr, and Ti.

A magnetic titania ultrathin film is especially used preferably by this invention as the transparent magnetic layer 312a. The super-thin film is expressed by the formula (2): Ti₂₋ₓMₓO₄ (where M is at least one kind of transition metal elements chosen from among V, Cr, Mn, Fe, Co, Ni, and Cu, and 0<x<2). It is chemical preparation about the layered titanium oxide crystallite which it was expressed with 0<x<2, and at least one kind of metal substituted for Ti lattice position in the magnetic element.

It is a magnetic semiconductor nano thin film which contains flake particles (called a nanosheet) obtained by exfoliating in one layer which is the basic minimum unit of a crystal structure.

The method of forming the lamination film 312 using the above-mentioned material may be to make the direction of a substrate slanting at the time of film formation and produce the film suitably using a vacuum film production method, such as vapor deposition, (or the oblique deposition method disclosed in Japanese Laid-Open Patent Application No. 5-132768). However, it is not necessarily restricted to this method, and a sheet-like thin film may be arranged aslant, which will be described later.

The magnetizing method which used the permanent magnet may be used for it, the magnetizing method using an electromagnet may be used for magnetization of the transparent magnetic layer 312a, it cannot be magnetized by a place or it can also be used. The magnetization direction and intensity can be chosen suitably.

Since the material which constitutes the transparent magnetic layer 312a forms a birefringence, a polarized light ray is isolated as disclosed in Japanese Laid-Open Patent Application No. 9-146064.

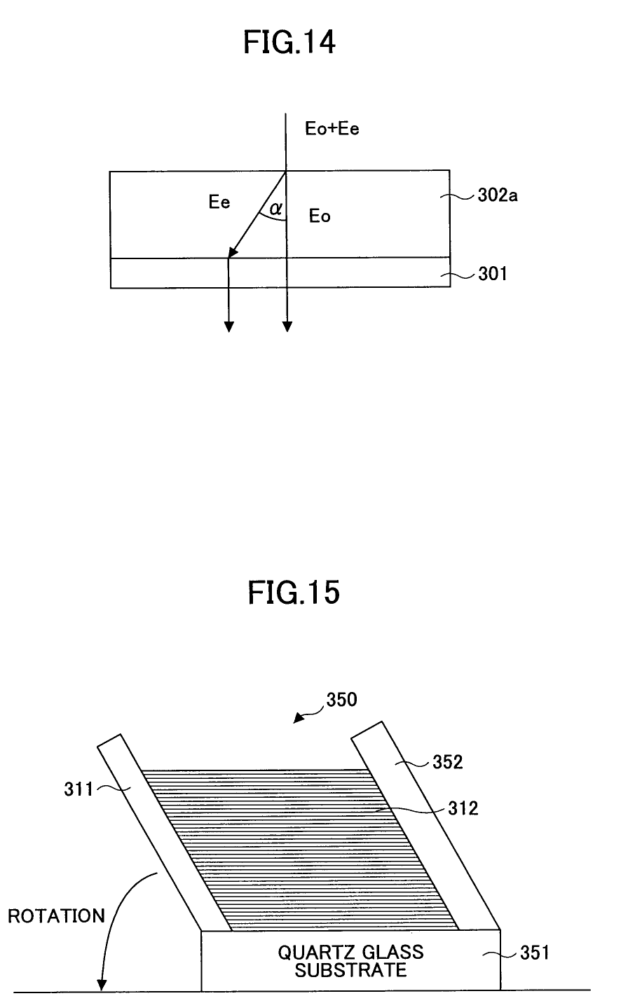

For example, as shown in FIG. 14, the polarized light ray (Eo) which enters at right angles to the surface of a transparent magnetic layer 302a formed on a transparent substrate 301 goes straight on. However, the plane of polarization depends on the thickness, and the plane of polarization rotates according to the Faraday effect.

Since the polarized light ray (Ee) is isolated aslant and propagates by the distance depending on the isolation angle α, it has an angle of rotation larger than that of the straight light ray. The planes of polarization of Eo and Ee are at right angles to each other, and the angle difference is 90 degrees.

In this invention, material and thickness are chosen and the polarization to take out is considering it as the polarization conversion component it was made to have the plane of polarization deflected to the uniform direction so that the rotation angle difference between this light that advanced aslant, and the light which went straight on may become a predetermined angle, for example, 90 degrees.

The plane-of-polarization rotation angle difference of the light rays may be 30 degrees, 45 degrees, 60 degrees, etc. not limited to 90 degrees. It is preferred to provide an antireflection film in the surface (light incidence side) of the lamination film 312.

It is preferred that each transparent magnetic layer 312a is a layered titania nanosheet in which the magnetic element is substituted for Ti lattice position in the molecular layer containing a titanium oxide.

That is, the nanosheet obtained by exfoliating in one layer which is the basic minimum unit of a crystal structure in the layered titanium oxide crystallite which the magnetic element substituted for Ti lattice position inclines aslant in a substrate side, and the transparent magnetic layer 312a is laminated and produced.

This titania nanosheet is transparent to visible light, and a refractive index is large (see Japanese Laid-Open Patent Application No. 2006-199556).

According to this invention, the lamination films 312 are efficiently formed by the method as shown in FIG. 15 which uses the nanosheet dispersion liquid with a spin coat method etc. applied.

Specifically, a substrate 311 and a quartz glass substrate 352 are arranged in parallel at a predetermined interval on the principal plane of a quartz glass substrate 351. Each end of the substrate 311 and the quartz glass substrate 352 is fixed to the principal plane of the quartz glass substrate 351 in the state where the substrate 311 and the quartz glass substrate 352 are inclined with a predetermined angle to the principal plane of the quartz glass substrate 351. Thus, a container 350 having the bottom of the quartz glass substrate 351 is produced.

Subsequently, a nanosheet dispersion liquid containing an organic substance is applied by a spin coat method to the bottom (quartz glass substrate 351) of the container 350 and it is dried, so that the titania nanosheets (which are the transparent magnetic layers 312a) and the organic layers 312b are formed.

At this time, since each nanosheet is extremely flat (for example, a size of 1 micrometer by 1 micrometer with a thickness of 1 nm), the nanosheets are deposited in parallel on the principal plane of the quartz glass substrate 351.

It is preferred that the titania nanosheets are produced by applying a strong magnetic field so that the magnetic flux is in parallel with the principal plane of the quartz glass substrate 351. This orientation processing enables a high arrangement feature to be given to the nanosheets.

As a dispersant of the titania nanosheet dispersion liquid, TBA (tetra-butyl-ammonium) is used preferably. Of course, other dispersants may be used. However, since the titania nanosheet has a negative electric charge, the material which does not generate condensation by electric combination is needed. TBA is used as a dispersant to an aqueous solvent. TBA can take the structure that wraps almost all of the surfaces of the nanosheet.

In production of the lamination film 312, spreading and dryness of the dispersion liquid (formation of the titania nanosheet as the transparent magnetic layer 312a, and the organic layer 312b) are repeatedly performed.

Subsequently, the substrate 311 is rotated as shown in FIG. 15, and the lamination film 312 having the slanting layered structure of periodic density as shown in FIG. 13 is formed.

Subsequently, the moisture contained in the films is evaporated by heating or using light, the lamination film 312 having a slanting density gradient and showing birefringence characteristics is obtained.

The interlayer spacing of the titania nanosheet is variable in accordance with the heating and UV processing conditions, etc., and therefore, the magneto optic effect is variable.

As the substitution magnetic element of the titania nanosheet may be Co, Fe, Ni, etc. If it is an atom which forms a ferromagnetic material, it will not be limited, and two or more atom substitution may be performed simultaneously.

When the faraday rotation angle is 30 degrees/micrometer and the polarization isolation angle is 25 degrees, the total thickness of the transparent magnetic layer 312a using the titania nanosheet is about 29 micrometers.

Even if the nanosheet did not have special treating operation, it was understood that it is easy to arrange in parallel with a substrate side from the characteristic super-flat shape in applying dispersion liquid as mentioned above with X-ray diffractometry etc.

When paint film dryness was carried out all over the strong magnetic field, it turned out that regularity improves sharply, X-ray diffraction intensity becomes large (one about 10 times the X-ray diffraction intensity of this will be obtained if it dries all over a three-tesla magnetic field), and a faraday rotation angle improves simultaneously.

Especially, if a strong parallel magnetic field with one or more teslas is applied, the nanosheet arrangement feature improves and the performance of the polarization conversion component of this invention can be raised.

As for the transparent magnetic layer 312a, it is preferred as above-mentioned that it is the layered titania nanosheet which two or more kinds of magnetic elements substituted for Ti lattice position in the molecular layer which contains titanium oxide. When the substitution atom of the titania nanosheet of one sheet was made into plurality, the large faraday rotation angle could be acquired, but even if it laminated two or more kinds of nanosheets with which substitution atoms differ, it turned out that a large faraday rotation angle is acquired.

For example, when substitution atoms differ like Co and Fe, if each nanosheet dispersion liquid is mixed and applied, the large faraday rotation angle of about ten degrees/micrometer can be acquired.

When it does in this way, the wavelength dependency of a faraday rotation angle can be changed suitably, and it is desirable.

As for the incident light to lamination film (birefringent film) 312, it is preferred that it is a parallel ray perpendicular to a film surface. Thereby, with the polarization conversion component of this invention, a parallel beam enters at right angles to the principal plane of the substrate 311, and is emitted only as plane polarization deflected to the specific direction.

About the circularly polarized light emitted from the light source, by optical elements, such as a convex lens, it is good and this parallel beam is a parallel ray, then a thing which obtains unification and parallel arrangement of a polarization emitting port by this.

As an optical element, a plastic lens array etc. is used preferably.

A paramagnetic substance, an antiferromagnetic substance, a ferrimagnetic substance, etc. can be used in addition to a ferromagnetic material as a material (transparent magnetic substance) which constitutes the transparent magnetic layer 312a of this invention.

When changing a magnetizing direction by turns by an external magnetic field, using a ferromagnetic material as a transparent magnetic substance (the direction of a magnetic spin is reversed), the direction of rotation of a plane of polarization becomes reverse.

If a polarizer is arranged to a light emitting surface, according to this external magnetic field change, switching and transmitted light amount change of light will be attained.

If a paramagnetic substance is used as a transparent magnetic substance, the effect which mentioned the external magnetic field above at the time of impression when giving change without impression or impression with the magnetic coil etc. will be acquired, but since Faraday rotation will not be produced if impression is stopped, it is separable into two kinds of plane polarization. As such a paramagnetic substance, there are Tb₃Al₅O₁₂, Tb₃Ga₅O₁₂, etc.

Since change of magnetization answers at high speed (about several nanoseconds), high-speed switching of plane polarization is attained.

It may not be winding at the magnetic field development for generating a magnetic field from the exterior, or straight line wiring is sufficient. Even if it is not metallic wiring like Au, Ag, Al, and Pt and uses transparent electric conduction films, such as SnO₂, In₂O₃, and ZnO, the magnetizing direction of a transparent magnetic substance can be reversed easily.

Organic substance transparent conductive materials, such as BEDO-TTF complex having an ethylene dioxy group, and CT complex using C60 dielectric, may also be used.

In the polarization conversion component of this invention, the direction of dip of each lamination film 312 may turn into an opposite direction mutually using the polarization conversion component of the pair with same angle of gradient to the substrate side of each lamination film 312, the two linearly polarized rays isolated by the element plane of incidence can be used as the laminated type polarization conversion component which emits a plane-of-polarization angle difference as 90 degrees from an element light emitting surface.

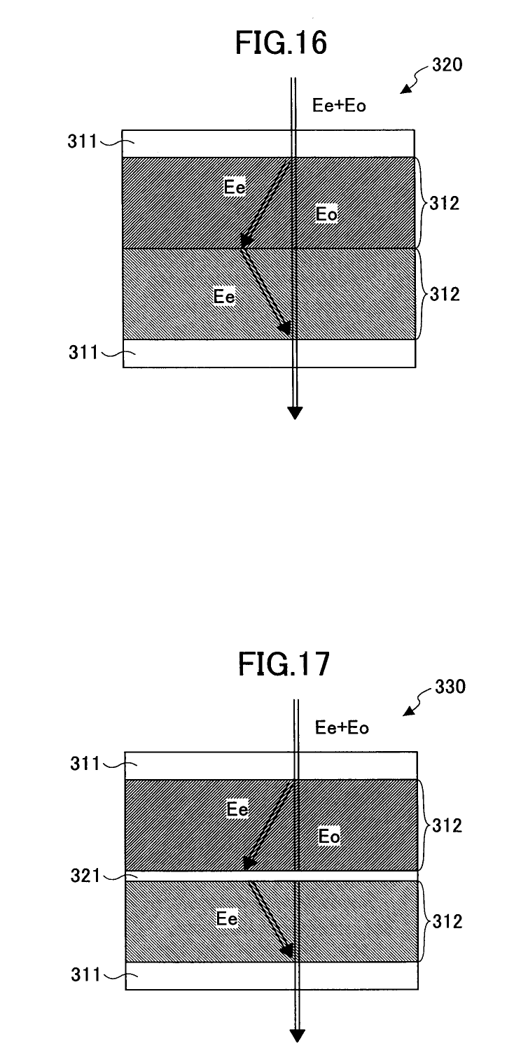

The composition of a laminated type polarization conversion component in an embodiment of the invention is shown in FIG. 16.

The polarization conversion components 310 of this invention are piled up to form the laminated type polarization conversion components 320, and the slanting repetition layer structure of the periodic density of each element is at the same angle to the principal plane of the substrate 311 and each direction is opposite.

The two linearly polarized rays (Eo and Ee) isolated by the element plane of incidence make a plane-of-polarization angle difference 90 degrees at the time of element side outgoing radiation.

By piling up the polarization conversion components 310, the feature that the separated polarization certainly laps in the polarization and the emitting port which went straight on unlike the polarization conversion components 310 appears.

It can use without the information which incident light had, the sexual desire news of a color image, concentration information, story tonality information, etc. dissociating.

Each surface which doubles two layers fully needs to take care so that light scattering may not happen. For example, pasting, continuation film production, etc. in the mirror plane state are preferred.

The number of the pairs of polarization conversion components 310 may be plural, and if it is plural, the thickness of each lamination film 312 cannot be made thin also.

In the laminated type polarization conversion component 320, plane smooth nature is important for the interface which the polarization conversion component 310 piled up with the pear up and down in order to decrease dispersion of light.

It was confirmed that it is considered as a unit to abolish this light scattering as much as possible, light scattering is sharply abolished by forming the transparent film 321 in an interface by nonmagnetic as shown in FIG. 17, and the utilization efficiency of light may be raised.

The following inorganic substance, the organic substance, etc. are suitably used for the transparent nonmagnetic film 321, for example.

That is, it is as an inorganic substance. and a stable substance is thermally it is transparent and suitable, and the oxide of metal or semimetal, they are nitride, chalcogenite, fluoride, carbide, and these mixtures.

Specifically, simple substances or these mixtures, such as SiO₂, SiO, Al₂O₃, GeO₂, In₂O₃, Ta₂O₅, TeO₂, TiO₂, MoO₃, WO₃, ZrO₂, Si₃N₄, AlN, BN, TiN, ZnS, CdS, CdSe, ZnSe, ZnTe, AgF, PbF₂, MnF₂, NiF2, and SiC, are mentioned.

As an example of the organic substance, functional molecules, such as high molecular compounds, such as substances in the living body, such as a natural product of a fats-and-oils compound, a sugar compound, a peptide compound, etc., enzyme, and a sea natural product, a synthetic resin, and an elastomer compound, a colloid compound, and a clathrate compound, etc. are mentioned, for example.

The method of applying the transparent nonmagnetic film 321 which contains an organic substance by a thickness of several micrometers can also double and attain the purpose referred to as joining the pair of lamination films 312 which have an inverse inclination respectively, and is preferred.

The lower one of the refractive index of the transparent nonmagnetic film 321 is preferred. Although there is no restriction in particular in thickness, the thinner one is important for giving the homogeneity of thickness preferably.

When the degree of separation angle of each of the pair of lamination films 312 is inadequate in the laminated type polarization conversion component 320, the laminated type polarization conversion component of this invention can be formed small and light, without thickening thickness of the lamination film 312 by increasing a plane-of-polarization angle of rotation using multipath reflection on both sides of the upper and lower sides with the dielectric film.

That is, by being reflected with a dielectric film, and penetrating, going and coming back to another optical path between two or more times the lamination film 312, the difference in a plane-of-polarization angle of rotation can become large, can lessen that the thickness of the lamination film 312 lowers that it is thin, i.e., transmissivity, as much as possible, and two polarization by which polarized light separation was carried out can attain polarization conversion.

Examples of the materials suitably used as the dielectric film are thermally stable transparent substances and they include the oxide of metal or semimetal, nitride, chalcogenite, fluoride, carbide, and their mixtures.

Specifically, the examples of the materials of the dielectric film may include simple substances or their mixtures, such as SiO₂, SiO, Al₂O₃, GeO₂, In₂O₃, Ta₂O₅, TeO₂, TiO₂, MoO₃, WO₃, ZrO₂, Si₃N₄, AlN, BN, TiN, ZnS, CdS, CdSe, ZnSe, ZnTe, AgF, PbF₂, MnF₂, NiF₂, and SiC.

It is necessary to choose a material with a refractive index smaller than that of the transparent magnetic layer 312a from among these materials. It is preferred to make each thickness in a range of 5-200 nm. It is more preferred to make it in a range of 5-30 nm. The dielectric film may be a lamination of two or more layers. The film is produced using any of various kinds of PVD and CVD methods.

According to the present invention, it is possible to increase the Faraday rotation angle for the composition in which a polarized light ray propagates in a slanting direction.

Moreover, according to the present invention, the Faraday effect increase is possible for the lamination film 312 which has a thickness of 1 micrometer or more.

Next, some examples of the polarization conversion component in this embodiment will be explained.

### Example 1

Potassium carbonate (K₂CO₃), titanium dioxide (TiO₂), cobalt oxide (CoO), and iron oxide (Fe₂O₃) were weighed and mixed to obtain a molar ratio of K_{0.8}Ti_{1.6}Co_{0.4}O₄ and K_{0.8}Ti_{1.2}Fe_{0.8}O₄. It was calcinated at 800 degrees C. for 40 hours, and magnetic element substitution potassium titanates (K_{0.8}Ti_{1.6}Co_{0.4}O₄, K_{0.8}Ti_{1.2}Fe_{0.8}O₄) were compounded.

It was made to react at room temperature by contacting the magnetic element substitution potassium titanates (K_{0.8}Ti_{1.6}Co_{0.4}O₄, K_{0.8}Ti_{1.2}Fe_{0.8}O₄) to hydrochloric acid 1N solution at a ratio of 1 g of particles to 100 cm³, and was sometimes agitated.

After repeating the operation to exchange new hydrochloric acid solution day by day 3 times, the filtration and rinsing of the solid state substance was carried out, it was air-dry, to obtain layered titanic acid particles.

Subsequently, 0.5 g of the obtained layered titanic acid particles (K_{0.8}Ti_{1.6}Co_{0.4}O₄ nH₂O, K_{0.8}Ti_{1.2}Fe_{0.8}O₄ nH₂O) was added to 100 cm³ of tetra-butyl ammonium hydroxide solution, and it was shaked (150 rpm) for one week at room temperature to obtain a milky titania sol.

Hereafter, the dispersion liquid of K_{0.8}Ti_{1.6}Co_{0.4}O₄ nH₂O is called Co-substituted titania nanosheet dispersion liquid, and the dispersion liquid of K_{0.8}Ti_{1.2}Fe_{0.8}O₄ nH₂O is called Fe-substituted titania nanosheet dispersion liquid.

The ultrasonic washer distributed the dispersion liquid which mixed the above-mentioned Co-substituted titania nanosheet dispersion liquid and Fe-substituted titania nanosheet dispersion liquid next, and mixture dispersion liquid was obtained. Gelatin whose solid concentration is 10 wt % of the nanosheet was added to the mixture dispersion liquid.

Then, after carrying out a surface polish, the quartz glass plate ends to which the release agent was applied were matched, and the container 350 as shown in FIG. 15 was produced. A small amount of the above mixture dispersion liquid was supplied to this container and the thin film was formed. The 3-tesla magnetic field was applied in the direction parallel to the surface (the nanosheet surface) of the thin film, and it was dried slowly. After this, it was taken out from the magnetic field, and heated at 100 degrees C.

The same processing was repeated, and the lamination of the nanosheets (which forms the lamination film 312) was performed until the thickness may be set to about 52 micrometers. The quartz glass plate other than the substrate 311 of the silica glass used as the substrate was removed, and the lamination nanosheet was picked out from the container.

The obtained lamination nanosheet was transparent, and when the light with the wavelength of 450 nm was entered at right angles to the nanosheet surface, the faraday rotation angle was 17 degrees/micrometer. The primary peak intensity which indicates the maximum intensity in the X-ray diffraction chart (corresponding to the lamination cycle of the nanosheets; the diffraction angle: 4.7 degrees) when the magnetic field was applied was about 10 times as large as in the case in which no magnetic field was applied, and the arrangement feature was improved. The Faraday rotation angle was also improved about 3 times.

When the light with the wavelength of 450 nm was entered in the lamination nanosheet in the direction perpendicular to the surface of the silica glass substrate 311 as shown in FIG. 3, the isolated polarized light ray was the linearly polarized light ray, the planes of polarization were mutually perpendicular, and the isolation angle was 25 degrees.

Subsequently, when this lamination nanosheet was magnetized at right angles to the film surface and light with the wavelength of 450 nm was entered like the above using the electromagnet which can impress the magnetic field of 1 k gauss, only the linearly polarized light ray was emitted at right angles to the arrangement surface of the nanosheets.

### Example 2

A lamination nanosheet of 26-micrometer thickness was produced similar to the Example 1. This lamination nanosheet and the lamination nanosheet produced in the Example 1 were arranged so that the inclinations of the slanting repetition layers with the periodic density may be opposite. After this, they were laminated together before dryness using PVA (polyvinyl alcohol), and the laminated type polarization conversion component shown in FIG. 17 was produced.

When the light with the wavelength of 450 nm was entered in the direction perpendicular to the surface of the silica glass substrate 311 in the laminated type polarization conversion component, the isolated polarized light ray was the linearly polarized light ray and the plane of polarization was perpendicular.

On the other hand, when the lamination nanosheet was magnetized like the Example 1 and the light with the wavelength of 450 nm was entered in the direction perpendicular to the surface of the silica glass substrate 311 in the same manner, the isolated polarized light ray was the linearly polarized light ray and the plane of polarization was parallel, effecting the polarization conversion.

### Example 3

A lens was arranged on the lamination nanosheet produced in the Example 1 so that the light entering the nanosheet surface may be a parallel light ray. The light with the wavelength of 450 nm was separated from the diverging light from a lamp light source and it was entered to the silica glass substrate 311. As a result, the isolated polarized light ray was the linearly polarized light ray and the plane of polarization was perpendicular. The intensity of the transmitted light was increased 12% larger than in the case of the Example 1.

On the other hand, when the lamination nanosheet was magnetized like the Example 1 and the light with the wavelength of 450 nm was entered in the direction perpendicular to the surface of the silica glass substrate 311 in the same manner, the isolated polarized light ray was the linearly polarized light ray and the plane of polarization was parallel, effecting the polarization conversion.

### Example 4

In the lamination nanosheet produced in the Example 1 before the magnetization, the magnetic poles were arranged on the upper and lower sides of the substrate 311 and the electromagnet was arranged so that a magnetic field may be applied in the direction perpendicular to the principal plane of the silica glass substrate 311. The magnetic field strength applied to the lamination nanosheet surface by the electromagnet was about 1 k gauss.

When the current switch of the electromagnet was tuned OFF (no current flow), both the polarized light rays due to the polarized light separation were observed simultaneously. On the other hand, when it was turned ON (the current flow arises), the planes of polarization were mutually parallel, effecting the polarization conversion. The same observations were obtained repeatedly.

### Example 5

A film of Ta₂O₅ was formed to a thickness of 450 nm on a quartz glass plate using the ion-plating method in which the oxygen gas pressure was set to 1.1×10⁻⁴ torr and the deposition rate was set to 0.5 nm/second without heating the glass substrate.

Subsequently, like the Example 1, the lamination nanosheet was formed to a thickness of 28 micrometers on the silica glass, and further the film of Ta₂O₅ was formed to a thickness of 450 nm on the lamination nanosheet surface similarly.

When the light with the wavelength of 450 nm was entered in the direction perpendicular to the surface of the quartz glass substrate like the Example 1, the isolated polarized light ray was the linearly polarized light ray and the plane of polarization was parallel, effecting the polarization conversion.

The present invention is not limited to the specifically disclosed embodiments, and variations and modifications may be made without departing from the scope of the present invention.

The present application is based on Japanese patent application No. 2007-158289, filed on Jun. 15, 2007, Japanese patent application No. 2007-158290, filed on Jun. 15, 2007, and Japanese patent application No. 2007-158291, filed on Jun. 15, 2007, the contents of which are incorporated herein by reference in their entirety.

What is claimed is:

1. A magnetic film, comprising:
a titania nanosheet which is formed on a transparent substrate and contains a layered titanium oxide in which at least one magnetic element is substituted for a Ti lattice position, the titanium oxide being expressed by a formula: Ti₂₋ₓMₓO₄ where M is at least one kind of transition metal elements chosen from among V, Cr, Mn, Fe, Co, Ni, and Cu, and 0<x<2;
a dispersant surrounding the titania nanosheet; and
a water-soluble organic compound.

2. The magnetic film according to claim 1 wherein the water-soluble organic compound is a gelatin.

3. The magnetic film according to claim 1, wherein the nanosheet contains a mixture of first and second nanosheet components, the first nanosheet component containing a layered titanium oxide in which Co is substituted for a Ti lattice position, the second nanosheet component containing a layered titanium oxide in which Fe is substituted for a Ti lattice position, and the nanosheet is transparent to a visible light.

4. The magnetic film according to claim 1, wherein the substrate has a surface treatment layer which is arranged to reduce a surface contact angle.

5. The magnetic film according to claim 1, wherein the magnetic film is formed in straight-line grooves periodically arranged with a constant pitch on a surface of the substrate.

6. The magnetic film according to claim 1, wherein a nanosheet dispersion liquid, containing particles of the layered titanium oxide in which the at least one magnetic element is substituted for the Ti lattice position, the dispersant, and the water-soluble organic compound, is applied to the transparent substrate and held in a dry state in which a magnetic field is applied to the titania nanosheet.

7. A magnetic recording/reproducing device, comprising:
a lamination film formed on a transparent substrate and containing a laminated structure of titania nanosheets and polymer layers, each titania nanosheet containing a layered titanium oxide in which at least one magnetic element is substituted for a Ti lattice position, the titanium oxide being expressed by a formula: Ti₂₋ₓMₓO₄ where M is at least one kind of transition metal elements chosen from among V, Cr, Mn, Fe, Co, Ni, and Cu, and 0<x<2;
a magnetic field applying unit applying a magnetic field to the lamination film in a direction perpendicular to a surface of the lamination film;
a laser light source outputting a laser beam;
a light converging unit causing the laser beam to converge on an arbitrary position in the lamination film; and
a rotation angle measuring instrument measuring an angle of rotation of a plane of polarization of the laser beam of the laser light source output from the lamination film.

8. The magnetic recording/reproducing device according to claim 7, wherein a laser beam with a first wavelength is output from the laser light source when recording information in the titania nanosheets, and a second laser beam with a second wavelength larger than the first wavelength is output from the laser light source when reproducing information from the titania nanosheets.

9. The magnetic recording/reproducing device according to claim 7, wherein the lamination film contains two or more kinds of titania nanosheets which differ in wavelength dependency in a Faraday rotation angle.

10. The magnetic recording/reproducing device according to claim 7, wherein the lamination film contains two or more kinds of titania nanosheets which differ in wavelength dependency in an absorbance.

11. The magnetic recording/reproducing device according to claim 7, wherein the lamination film is arranged discontinuously on the transparent substrate in a two-dimensional formation.

12. The magnetic recording/reproducing device according to claim 7, wherein the laser light source, the light converging unit, the magnetic field applying unit, and the rotation angle measuring instrument are integrated into a unified module, and a part of the lamination film where recording or reproducing of information is performed is changed by a relative movement of the unified module and the lamination film.

13. The magnetic recording/reproducing device according to claim 7, wherein the rotation angle measuring instrument is a polarization detector in which a titanium oxide film and a thin film of conjugate polymer orientation are combined.

14. A polarization conversion component comprising:
a substrate; and
a lamination film formed on a surface of the substrate slantingly with a given inclination angle to the surface of the substrate, the lamination film including an alternate lamination of transparent magnetic layers and transparent organic layers, each transparent magnetic layer containing a layered titanium oxide in which at least one magnetic element is substituted for Ti lattice positions, the titanium oxide being expressed by a formula: Ti₂₋ₓMₓO₄ where M is at least one kind of transition metal elements chosen from among V, Cr, Mn, Fe, Co, Ni, and Cu, and 0<x<2;
wherein a birefringence is formed by a layered structure of the lamination film in which a density of the lamination film changes to the substrate periodically and slantingly based on a difference in density between the magnetic layers and the organic layers,
wherein a thickness of the lamination film is adjusted so that, when a light ray enters at right angles to the surface of the substrate, the polarization conversion component outputs a linearly polarized light ray along a specific polarization direction.

15. The polarization conversion component according to claim 14, wherein the transparent magnetic layer is made of a layered titania nanosheet in which two or more kinds of magnetic elements are substituted for Ti lattice positions in a molecular layer containing a titanium oxide.

16. The polarization conversion component according to claim 14, wherein, when parallel light rays produced from a light ray from a light source by an optical element enter the surface of the substrate at right angles, the polarization conversion component outputs a linearly polarized light ray along a specific polarization direction.

17. The polarization conversion component according to claim 14, wherein a magnetizing direction of the transparent magnetic layer is variable.
